(19) United States
(12) Patent Application Publication
(10) Pub. No.: US 2014/0375119 A1
(43) Pub. Date: Dec. 25, 2014

(54) SECONDARY BATTERY, METHOD OF MANUFACTURING THE SAME, BATTERY PACK, ELECTRIC VEHICLE, ELECTRIC POWER STORAGE SYSTEM, ELECTRIC POWER TOOL, AND ELECTRONIC APPARATUS

(71) Applicant: Sony Corporation, Tokyo (JP)

(72) Inventors: Aiko NAKAMURA, Kanagawa (JP); Takatoshi MUNAOKA, Kanagawa (JP); Takayuki ITO, Kanagawa (JP)

(21) Appl. No.: 14/306,490

(22) Filed: Jun. 17, 2014

(30) Foreign Application Priority Data
Jun. 24, 2013 (JP) 2013-131639

(51) Int. Cl. H01M 4/13; B60L 11/18; H01M 10/058; H01M 10/0565; H01M 10/0525

(52) U.S. Cl. CPC H01M 4/13; H01M 10/0565; H01M 10/0525; H01M 10/058; B60L 11/18; H01M 2220/20; H01M 2220/30; H01M 2004/021
USPC 307/9.1; 429/209; 429/122; 427/58

(57) ABSTRACT

A secondary battery includes: an electrode including an active material layer; and an electrolyte layer provided on the active material layer, wherein area density of the active material layer is equal to or larger than about 40 milligrams per square centimeter, the electrolyte layer includes a polymer compound and an electrolytic solution, and by surface observation of the electrolyte layer, (A) circular regions are not observed, or (B) one or more circular regions are observed, and an average diameter of the circular regions is equal to or less than about 1.3 millimeters.

### CROSS REFERENCES TO RELATED APPLICATIONS

The present application claims priority to Japanese Priority Patent Application JP 2013-131639 filed in the Japan Patent Office on Jun. 24, 2013, the entire content of which is hereby incorporated by reference.

### BACKGROUND

The present application relates to a secondary battery including an electrolyte layer containing a polymer compound and an electrolytic solution, to a method of manufacturing the secondary battery, and to a battery pack, an electric vehicle, an electric power storage system, an electric power tool, and an electronic apparatus that use the secondary battery.

In recent years, various electronic apparatuses such as a mobile phone and a personal digital assistant (PDA) have been widely used, and it has been demanded to further reduce the size and the weight of the electronic apparatuses and to achieve their long lives. Accordingly, as an electric power source for the electronic apparatuses, a battery, in particular, a small and light-weight secondary battery capable of providing high energy density has been developed.

In these days, it has been considered to apply such a secondary battery not only to the electronic apparatuses but also to other applications. Examples of such other applications may include a battery pack attachably and detachably mounted on the electronic apparatuses or the like, an electric vehicle such as an electric automobile, an electric power storage system such as a home electric power server, and an electric power tool such as an electric drill.

Secondary batteries utilizing various charge and discharge principles to obtain a battery capacity have been proposed. In particular, a secondary battery utilizing insertion and extraction of an electrode reactant has attracted attention, since such a secondary battery provides higher energy density than a lead battery, a nickel-cadmium battery, and the like.

The secondary battery includes electrodes (a cathode and an anode) and an electrolytic solution as a liquid electrolyte. The electrodes include an active material layers containing an active material, and the electrolytic solution contains a solvent and an electrolyte salt. In a secondary battery including an electrolytic solution, while high ion conductivity is obtained, a defect such as corrosion may occur due to leakage of the electrolytic solution.

Accordingly, recently, an electrolyte layer as a gel electrolyte has been used in order to prevent such leakage of the electrolytic solution. The electrolyte layer contains a polymer compound together with the electrolytic solution, and the electrolytic solution is supported by the polymer compound.

In a step of forming the electrolyte layer, after a solution containing the polymer compound and the electrolytic solution is prepared, the surface of an active material layer is coated with the solution. Thereby, the electrolyte layer containing the electrolytic solution and the polymer compound is formed to cover the surface of the active material layer. In this case, in order to obtain superior battery characteristics, it is necessary to allow the electrolytic solution in the electrolyte layer to permeate the active material layer as much as possible.

Therefore, in order to improve solution permeability with respect to an active material layer, the surface of the active material layer is coated with solutions several times (for example, see Japanese Unexamined Patent Application Publication No. 2000-173656). In this case, after the surface of the active material layer is coated with a low-viscosity solution, the surface of the active material layer is coated with a high-viscosity solution.

### SUMMARY

However, since solution permeability with respect to the active material layer is not sufficient yet, battery characteristics may be lowered.

It is desirable to provide a secondary battery, a method of manufacturing the secondary battery, a battery pack, an electric vehicle, an electric power storage system, an electric power tool, and an electronic apparatus that are capable of obtaining superior battery characteristics.

According to an embodiment of the present application, there is provided a secondary battery including: an electrode including an active material layer; and an electrolyte layer provided on the active material layer, wherein area density of the active material layer is equal to or larger than about 40 milligrams per square centimeter, the electrolyte layer includes a polymer compound and an electrolytic solution, and by surface observation of the electrolyte layer, (A) circular regions are not observed, or (B) one or more circular regions are observed, and an average diameter of the circular regions is equal to or less than about 1.3 millimeters.

According to an embodiment of the present application, there is provided another secondary battery including: an electrode including an active material layer; and an electrolyte layer provided on the active material layer, wherein the electrolyte layer is formed by supplying a non-aqueous liquid not containing a polymer compound to a surface of the active material layer, and subsequently supplying a non-aqueous solution containing an electrolytic solution together with the polymer compound to a surface of the active material layer.

According to an embodiment of the present application, there is provided a method of manufacturing a secondary battery, wherein an active material layer is formed, and an electrolyte layer is formed by supplying a non-aqueous liquid not containing a polymer compound to a surface of the active material layer, and supplying a non-aqueous solution containing an electrolytic solution together with the polymer compound to the surface of the active material layer supplied with the non-aqueous liquid.

According to an embodiment of the present application, there is provided a battery pack including: a secondary battery; a control section configured to control operation of the secondary battery; and a switch section configured to switch the operation of the secondary battery according to an instruction of the control section, wherein the secondary battery includes an electrode including an active material layer, and an electrolyte layer provided on the active material layer, area density of the active material layer is equal to or larger than about 40 milligrams per square centimeter, the electrolyte layer includes a polymer compound and an electrolytic solution, and by surface observation of the electrolyte layer, (A) circular regions are not observed, or (B) one or more circular regions are observed, and an average diameter of the circular regions is equal to or less than about 1.3 millimeters.

According to an embodiment of the present application, there is provided an electric vehicle including: a secondary battery; a conversion section configured to convert electric power supplied from the secondary battery into drive power; a drive section configured to operate according to the drive power; and a control section configured to control operation of the secondary battery, wherein the secondary battery includes an electrode including an active material layer, and an electrolyte layer provided on the active material layer, area density of the active material layer is equal to or larger than about 40 milligrams per square centimeter, the electrolyte layer includes a polymer compound and an electrolytic solution, and by surface observation of the electrolyte layer, (A) circular regions are not observed, or (B) one or more circular regions are observed, and an average diameter of the circular regions is equal to or less than about 1.3 millimeters.

According to an embodiment of the present application, there is provided an electric power storage system including: a secondary battery; one or more electric devices configured to be supplied with electric power from the secondary battery; and a control section configured to control the supplying of the electric power from the secondary battery to the one or more electric devices, wherein the secondary battery includes an electrode including an active material layer, and an electrolyte layer provided on the active material layer, area density of the active material layer is equal to or larger than about 40 milligrams per square centimeter, the electrolyte layer includes a polymer compound and an electrolytic solution, and by surface observation of the electrolyte layer, (A) circular regions are not observed, or (B) one or more circular regions are observed, and an average diameter of the circular regions is equal to or less than about 1.3 millimeters.

According to an embodiment of the present application, there is provided an electric power tool including: a secondary battery; and a movable section configured to be supplied with electric power from the secondary battery, wherein the secondary battery includes an electrode including an active material layer, and an electrolyte layer provided on the active material layer, area density of the active material layer is equal to or larger than about 40 milligrams per square centimeter, the electrolyte layer includes a polymer compound and an electrolytic solution, and by surface observation of the electrolyte layer, (A) circular regions are not observed, or (B) one or more circular regions are observed, and an average diameter of the circular regions is equal to or less than about 1.3 millimeters.

According to an embodiment of the present application, there is provided an electronic apparatus including a secondary battery as an electric power supply source, wherein the secondary battery includes an electrode including an active material layer, and an electrolyte layer provided on the active material layer, area density of the active material layer is equal to or larger than about 40 milligrams per square centimeter, the electrolyte layer includes a polymer compound and an electrolytic solution, and by surface observation of the electrolyte layer, (A) circular regions are not observed, or (B) one or more circular regions are observed, and an average diameter of the circular regions is equal to or less than about 1.3 millimeters.

According to embodiments of the present application, there are provided a battery pack, an electric vehicle, an electric power storage system, an electric power tool, and an electronic apparatus, each including a secondary battery, wherein the secondary battery has a configuration similar to that of the secondary battery according to the above-described embodiment of the present application.

For the foregoing “surface observation of the electrolyte layer,” any one or more of microscopes such as an optical microscope are used.

The foregoing term “circular region” refers to a substantially circular region observed in a photomicrograph, and may be a vestige caused by, for example, air bubbles mixed therein mainly in a step of forming the electrolyte layer. The shape (the outline shape) defined by the outer rim of the vestige may be substantially circular, and is not limited to a true circle. That is, the outline shape is not particularly limited, as long as the outline shape is a shape with its outline including a curved line, and may be an oval or other shape. Further, internal color of the vestige is light color (color relatively close to white), while outer color (base color) of the vestige is dark color (color relatively close to black). Therefore, due to the contrasting density (contrast), the vestige is visually recognized as a circular region. However, the circular region includes not only a region in which the internal color is light color entirely but also a region recognized ring-shaped (or crater-shaped) since color of portions other than the central portion out of the internal portion is light color. It is to be noted that the foregoing position relation of contrasting density (in which the internal portion of the vestige is light-colored and the outer portion thereof is dark-colored) may be reversed.

In the case where the number of the circular regions is one, the foregoing term “average diameter” refers to the diameter of such a circular region. In the case where the number of the circular regions is equal to or larger than two, the foregoing term “average diameter” refers to an average value of diameters of such two or more circular regions. The “average diameter” is obtained as follows. First, a surface of the electrolyte layer is observed (observation area size: 46 cm×4 cm, the number of observation areas: 1) to obtain a photomicrograph. Subsequently, with the use of the photomicrograph, diameters (mm) of the respective circular regions are measured. Finally, the average value of the diameters is calculated.

According to the secondary battery according to the embodiment of the present application, the electrolyte layer is formed by supplying the non-aqueous liquid not containing the polymer compound to the surface of the active material layer, and supplying the non-aqueous solution containing the electrolytic solution together with the polymer compound to the surface of the active material layer. Therefore, in the case where the area density of the active material layer is equal to or larger than 40 milligrams per square centimeter, circular regions are not observed by surface observation. Alternatively, in this case, when one or more circular regions are observed by the surface observation, the average diameter of the circular regions is equal to or less than 1.3 millimeters. Therefore, superior battery characteristics are obtainable. Further, according to the battery pack, the electric vehicle, the electric power storage system, the electric power tool, and the electronic apparatus according to the embodiments of the present application, similar effects are obtainable.

According to the method of manufacturing the secondary battery according to the embodiment of the present application, for forming the electrolyte layer, the non-aqueous liquid not containing the polymer compound is supplied to the surface of the active material layer, and the non-aqueous solution containing the electrolytic solution together with the polymer compound is supplied to the surface of the active material layer. Therefore, a secondary battery having superior battery characteristics is allowed to be manufactured.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a perspective view illustrating a configuration of a secondary battery according to an embodiment of the present application.

FIG. 2 is a cross-sectional view taken along a line II-II of a spirally wound electrode body illustrated in FIG. 1.

FIG. 3 is a cross-sectional view selectively illustrating part of the spirally wound electrode body illustrated in FIG. 2.

FIG. 4 is a photomicrograph for explaining an observation result of an electrolyte layer.

FIG. 5 is a photomicrograph for explaining another observation result of the electrolyte layer.

FIG. 6 is a diagram schematically illustrating the photomicrograph illustrated in FIG. 5.

FIG. 7 is a cross-sectional view for explaining causes of occurrence of circular regions.

FIG. 8 is a block diagram illustrating a configuration of an application example (a battery pack) of the secondary battery.

FIG. 9 is a block diagram illustrating a configuration of an application example (an electric vehicle) of the secondary battery.

FIG. 10 is a block diagram illustrating a configuration of an application example (an electric power storage system) of the secondary battery.

FIG. 11 is a block diagram illustrating a configuration of an application example (an electric power tool) of the secondary battery.

FIG. 12 is a cross-sectional view illustrating a configuration of a test-use secondary battery.

FIG. 13 is a photomicrograph illustrating a result of surface observation (Example 1-1) of an electrolyte layer.

FIG. 14 is a photomicrograph illustrating a result of surface observation (Example 1-2) of an electrolyte layer.

FIG. 15 is a photomicrograph illustrating a result of surface observation (Example 1-3) of an electrolyte layer.

FIG. 16 is a photomicrograph illustrating a result of surface observation (Example 1-4) of an electrolyte layer.

FIG. 17 is a photomicrograph illustrating a result of surface observation (Example 1-5) of an electrolyte layer.

FIG. 18 is a photomicrograph illustrating a result of surface observation (Example 1-8) of an electrolyte layer.

FIG. 19 is a photomicrograph illustrating a result of surface observation (Example 1-16) of an electrolyte layer.

### DETAILED DESCRIPTION

An embodiment of the present application will be described below in detail with reference to the drawings. The description will be given in the following order.

### 1. Secondary Battery

1-1. Configuration

1-2. Manufacturing Method

1-3 Function and Effect

1-4. Modifications

### 2. Applications of Secondary Battery

2-1. Battery Pack

2-2. Electric Vehicle

2-3. Electric Power Storage System

2-4. Electric Power Tool

[1. Secondary Battery]

First, description will be given of a secondary battery according to an embodiment of the present application.

[1-1. Configuration]

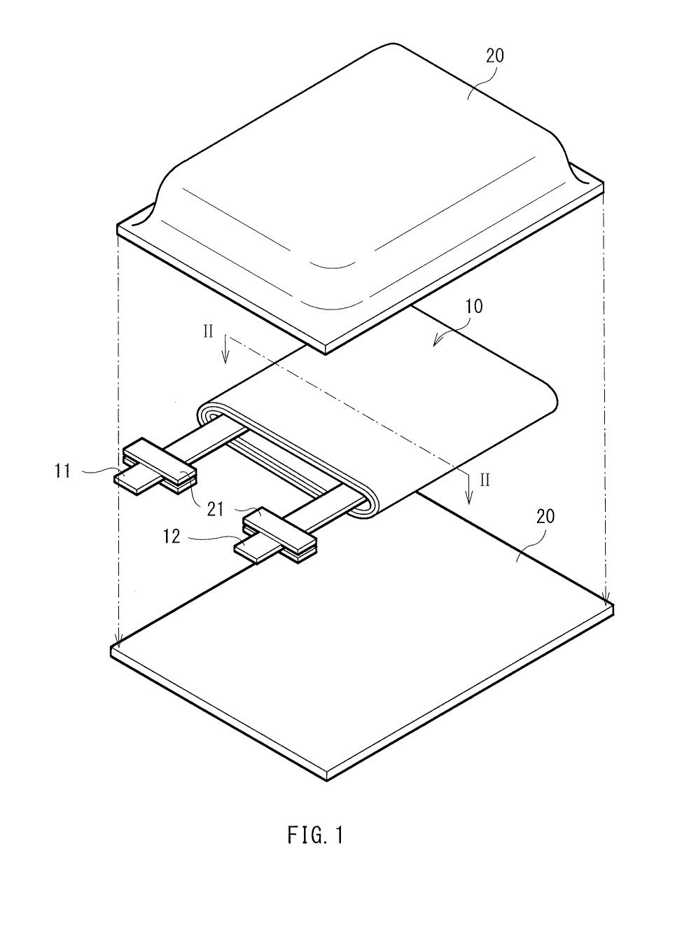

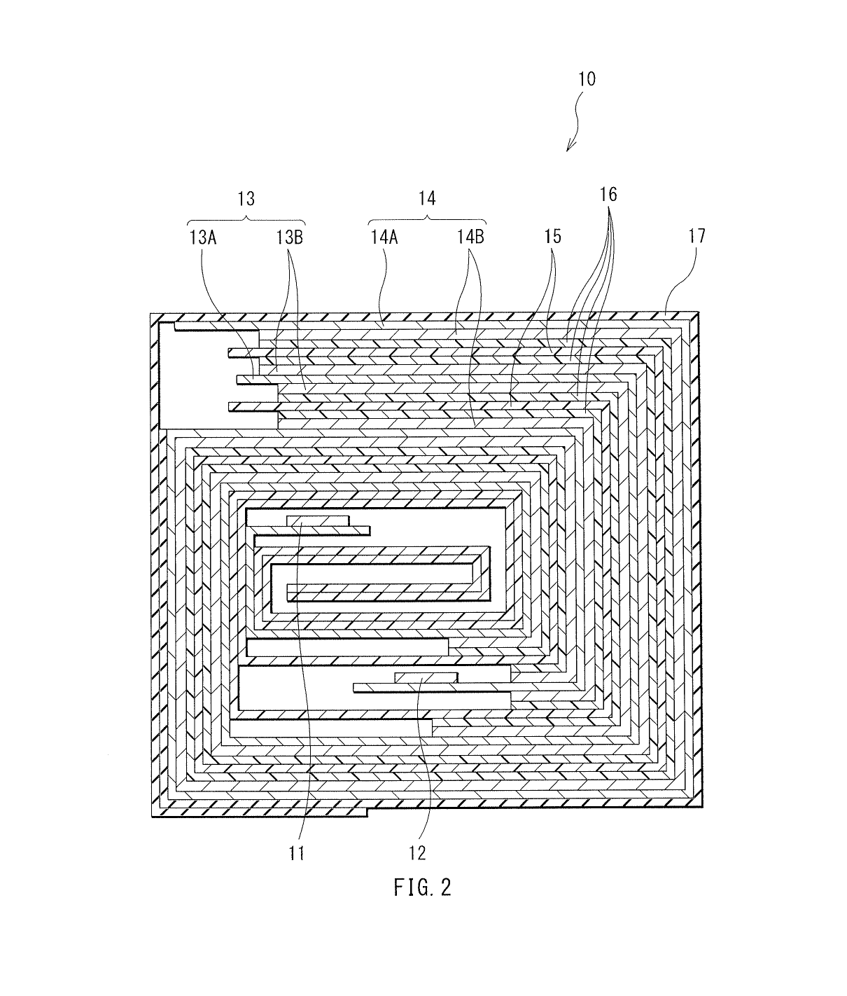

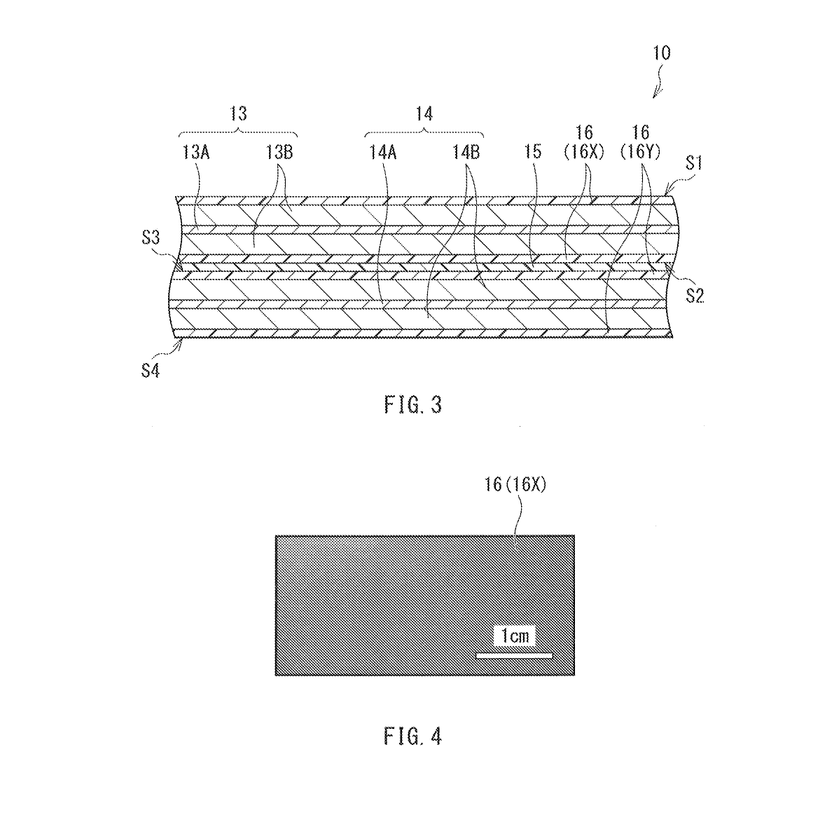

FIG. 1 illustrates a perspective configuration of the secondary battery. FIG. 2 illustrates a cross-sectional configuration taken along a line II-II of a spirally wound electrode body 10 illustrated in FIG. 1. FIG. 3 illustrates a selective part of the spirally wound electrode body 10 illustrated in FIG. 2. FIG. 1 illustrates a state in which the spirally wound electrode body 10 is separated from two package members 20.

[Whole Configuration]

The secondary battery described here may be, for example, a lithium secondary battery (a lithium ion secondary battery) in which the capacity of an anode 14 is obtained by insertion and extraction of lithium (lithium ions) as an electrode reactant, and has a so-called laminated-film-type battery structure.

For example, the secondary battery contains the spirally wound electrode body 10 in a film-like outer package member 20. The spirally wound electrode body 10 may be formed, for example, by laminating a cathode 13 and an anode 14 with a separator 15 and an electrolyte layer 16 in between, and subsequently spirally winding the resultant laminated body. A cathode lead 11 is attached to the cathode 13, and an anode lead 12 is attached to the anode 14. The outermost periphery of the spirally wound electrode body 10 is protected by a protective tape 17.

The cathode lead 11 and the anode lead 12 may be, for example, led out from inside to outside of the outer package member 20 in the same direction. The cathode lead 11 may be made, for example, of any one or more of electrically-conductive materials such as aluminum. The anode lead 12 may be made, for example, of any one or more of electrically-conducive materials such as copper, nickel, and stainless steel. These electrically-conductive materials may be in the shape, for example, of a thin plate or mesh.

The outer package member 20 may be a laminated film in which, for example, a fusion bonding layer, a metal layer, and a surface protective layer are laminated in this order. The outer package member 20 may be formed, for example, by layering two laminated films so that the fusion bonding layers and the spirally wound electrode body 10 are opposed to each other, and subsequently fusion-bonding the respective outer edges of the fusion bonding layers to each other. Alternatively, the two laminated films may be attached to each other by an adhesive or the like. Examples of the fusion bonding layer may include any one or more of films made of polyethylene, polypropylene, and the like. Examples of the metal layer may include an aluminum foil. Examples of the surface protective layer may include any one or more of films made of nylon, polyethylene terephthalate, and the like.

In particular, as the outer package member 20, an aluminum laminated film in which a polyethylene film, an aluminum foil, and a nylon film are laminated in this order may be preferable. However, the outer package member 20 may be made of a laminated film having other laminated structure, a polymer film such as polypropylene, or a metal film.

For example, an adhesive film 21 to protect from outside air intrusion may be inserted between the outer package member 20 and the cathode lead 11 and between the outer package member 20 and the anode lead 12. The adhesive film 21 is made of a material having adhesibility with respect to the cathode lead 11 and the anode lead 12. Examples of the adhesive material may include a polyolefin resin. More specific examples thereof may include any one or more of polyethylene, polypropylene, modified polyethylene, modified polypropylene, and the like.

[Cathode]

The cathode 13 may have, for example, a cathode active material layer 13B on a single surface or both surfaces of a cathode current collector 13A. However, FIG. 2 and FIG. 3 may illustrate, for example, a case in which the cathode active material layer 13B is provided on both surfaces of the cathode current collector 13A.

The cathode current collector 13A may be made, for example, of any one or more of electrically-conductive materials such as aluminum, nickel, and stainless steel.

The cathode active material layer 13B contains, as cathode active materials, any one or more of cathode materials capable of inserting and extracting lithium. However, the cathode active material layer 13B may contain, for example, any one or more of other materials such as a cathode binder and a cathode electric conductor.

The cathode material may be preferably a lithium-containing compound, since thereby, high energy density is obtained. Examples of the lithium-containing compound may include a lithium-transition-metal composite oxide and a lithium-transition-metal-phosphate compound. The lithium-transition-metal composite oxide is an oxide containing lithium (Li) and one or more transition metal elements as constituent elements. The lithium-transition-metal-phosphate compound is a phosphate compound containing lithium and one or more transition metal elements as constituent elements. In particular, it may be preferable that the transition metal element be any one or more of cobalt (Co), nickel (Ni), manganese (Mn), iron (Fe), and the like, since a higher voltage is obtained thereby. The chemical formula of the lithium-transition-metal composite oxide may be expressed by, for example, LiₓM1O₂. The chemical formula of the lithium-transition-metal-phosphate compound may be expressed by, for example, Li_{y}M2PO₄. In the formulas, each of M1 and M2 represents one or more transition metal elements. Values of x and y vary according to the charge and discharge state, and may be, for example, in the range of 0.05≦x≦1.10 and 0.05≦y≦1.10.

Specific examples of the lithium-transition-metal composite oxide may include LiCoO₂, LiNiO₂, and a lithium-nickel-based composite oxide represented by the following Formula (1), and may include compounds other than the foregoing compounds. Specific examples of the lithium-transition-metal-phosphate compound may include LiFePO₄ and LiFe₁₋ᵤMnᵤPO₄ (u<1), and may include compounds other than the foregoing compounds. One reason for this is that, in this case, a high battery capacity is obtained and superior cycle characteristics and the like are obtained as well.

LiNi_{1-z}M_{z}O₂ (1)

In Formula (1), M is one or more of cobalt (Co), manganese (Mn), iron (Fe), aluminum (Al), vanadium (V), tin (Sn), magnesium (Mg), titanium (Ti), strontium (Sr), calcium (Ca), zirconium (Zr), molybdenum (Mo), technetium (Tc), ruthenium (Ru), tantalum (Ta), tungsten (W), rhenium (Re), ytterbium (Yb), copper (Cu), zinc (Zn), barium (Ba), boron (B), chromium (Cr), silicon (Si), gallium (Ga), phosphorus (P), antimony (Sb), and niobium (Nb); and z satisfies 0.005<z<0.5.

In addition thereto, the cathode material may be, for example, any one or more of an oxide, a disulfide, a chalcogenide, an electrically-conductive polymer, and the like. Examples of the oxide may include titanium oxide, vanadium oxide, and manganese dioxide. Examples of the disulfide may include titanium disulfide and molybdenum sulfide. Examples of the chalcogenide may include niobium selenide. Examples of the electrically-conductive polymer may include sulfur, polyaniline, and polythiophene. It goes without saying that the cathode material is not limited to one of the foregoing materials, and may be other material.

Examples of the cathode binder may include any one or more of synthetic rubbers, polymer materials, and the like. Examples of the synthetic rubber may include a styrene-butadiene-based rubber, a fluorine-based rubber, and ethylene propylene diene. Examples of the polymer material may include polyvinylidene fluoride and polyimide.

Examples of the cathode electric conductor may include any one or more of carbon materials and the like. Examples of the carbon materials may include graphite, carbon black, acetylene black, and Ketjen black. It is to be noted that the cathode electric conductor may be other material such as a metal material and an electrically-conductive polymer as long as the material has electric conductivity.

[Anode]

The anode 14 may have, for example, an anode active material layer 14B on a single surface or both surfaces of an anode current collector 14A. However, FIG. 2 and FIG. 3 may illustrate, for example, a case in which the anode active material layer 14B is provided on both surfaces of the anode current collector 14A.

The anode current collector 14A may be made, for example, of any one or more of electrically-conductive materials such as copper, nickel, and stainless steel.

The surface of the anode current collector 14A may be preferably roughened. Thereby, due to a so-called anchor effect, adhesibility of the anode active material layer 14B with respect to the anode current collector 14A is improved. In this case, it is enough that the surface of the anode current collector 14A in a region opposed to the anode active material layer 14B is roughened at minimum. Examples of roughening methods may include a method of forming fine particles by utilizing electrolytic treatment. The electrolytic treatment is a method of providing concavity and convexity on the surface of the anode current collector 14A by forming fine particles on the surface of the anode current collector 14A with the use of an electrolytic method in an electrolytic bath. A copper foil fabricated by an electrolytic method is generally called “electrolytic copper foil.”

The anode active material layer 14B contains any one or more of anode materials capable of inserting and extracting lithium as anode active materials. However, the anode active material layer 14B may contain, for example, any one or more of other materials such as an anode binder and an anode electric conductor. Details of the anode binder and the anode electric conductor may be, for example, similar to those of the cathode binder and the cathode electric conductor.

The chargeable capacity of the anode material may be preferably larger than the discharged capacity of the cathode 13 in order to prevent lithium metal from being unintentionally precipitated on the anode 14 in the middle of charge. That is, the electrochemical equivalent of the anode material capable of inserting and extracting lithium may be preferably larger than the electrochemical equivalent of the cathode 13.

Examples of the anode materials may include, for example, any one or more of carbon materials. In the carbon materials, crystal structure change at the time of insertion and extraction of lithium is extremely small. Therefore, the carbon materials provide high energy density and superior cycle characteristics. Further, the carbon materials serve as anode electric conductors as well.

Examples of the carbon materials may include graphitizable carbon, non-graphitizable carbon, and graphite. The spacing of (002) plane of the non-graphitizable carbon may be preferably equal to or greater than 0.37 nm, and the spacing of (002) plane of the graphite may be preferably equal to or smaller than 0.34 nm. More specifically, examples of the carbon materials may include pyrolytic carbons, cokes, glassy carbon fiber, an organic polymer compound fired body, activated carbon, and carbon blacks. Examples of the cokes may include pitch coke, needle coke, and petroleum coke. The organic polymer compound fired body is obtained by firing (carbonizing) a polymer compound such as a phenol resin and a furan resin at appropriate temperature. In addition thereto, examples of the carbon materials may include low crystalline carbon and amorphous carbon that are heat-treated at temperature equal to or less than about 1000 deg C. It is to be noted that the shape of any of the carbon materials may be any of a fibrous shape, a spherical shape, a granular shape, and a scale-like shape.

Further, examples of the anode materials may include a material (a metal-based material) containing any one or more of metal elements and metalloid elements as constituent elements, since high energy density is thereby obtained. Such a metal-based material may be any of a simple substance, an alloy, and a compound, may be two or more thereof, or may be a material having one or more phases thereof in part or all thereof. It is to be noted that “alloy” described here includes a material containing one or more metal elements and one or more metalloid elements, in addition to a material configured of two or more metal elements. Further, the “alloy” may contain a non-metallic element. Examples of the structure thereof may include a solid solution, a eutectic crystal (eutectic mixture), an intermetallic compound, and a structure in which two or more thereof coexist.

Examples of the foregoing metal elements and the foregoing metalloid elements may include any one or more of metal elements and metalloid elements that are capable of forming an alloy with lithium. Specific examples thereof may include Mg, B, Al, Ga, In, Si, Ge, Sn, Pb, Bi, Cd, Ag, Zn, Hf, Zr, Y, Pd, and Pt. In particular, silicon, tin, or both may be preferable, since silicon and tin have a superior ability of inserting and extracting lithium, and therefore, provide high energy density.

A material containing silicon, tin, or both as constituent elements may be any of a simple substance, an alloy, and a compound of silicon or tin, may be two or more thereof, or may be a material having one or more phases thereof in part or all thereof. It is to be noted that, the term “simple substance” merely refers to a general simple substance (a small amount of impurity may be therein contained), and does not necessarily refer to a purity 100% simple substance.

The alloys of silicon may contain, for example, any one or more of elements such as Sn, Ni, Cu, Fe, Co, Mn, Zn, In, Ag, Ti, Ge, Bi, Sb, and Cr as constituent elements other than Si. The compounds of Si may contain, for example, any one or more of C, O, and the like as constituent elements other than Si. It is to be noted that, for example, the compounds of silicon may contain any one or more of the elements described for the alloys of silicon as constituent elements other than Si.

Specific examples of the alloys of silicon and the compounds of silicon may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO. It is to be noted that v in SiOᵥ may be in the range of 0.2<v<1.4.

The alloys of tin may contain, for example, any one or more of elements such as Si, Ni, Cu, Fe, Co, Mn, Zn, In, Ag, Ti, Ge, Bi, Sb, and Cr as constituent elements other than Sn. The compounds of tin may contain, for example, any one or more of elements such as C and O as constituent elements other than Sn. It is to be noted that the compounds of tin may contain, for example, any one or more of elements described for the alloys of Sn as constituent elements other than Sn. Specific examples of the alloys of tin and the compounds of tin may include SnO_{w} (0<w≦2), SnSiO₃, LiSnO, and Mg₂Sn.

In particular, as a material containing Sn as a constituent element, for example, a material containing a second constituent element and a third constituent element in addition to Sn as a first constituent element may be preferable. Examples of the second constituent element may include any one or more of elements such as Co, Fe, Mg, Ti, V, Cr, Mn, Ni, Cu, Zn, Ga, Zr, Nb, Mo, Ag, In, Ce, Hf, Ta, W, Bi, and Si. Examples of the third constituent element may include any one or more of B, C, Al, P, and the like. In the case where the second constituent element and the third constituent element are contained, a high battery capacity, superior cycle characteristics, and the like are obtained.

In particular, a material (an SnCoC-containing material) containing Sn, Co, and C as constituent elements may be preferable. In the SnCoC-containing material, for example, the C content may be from 9.9 mass % to 29.7 mass % both inclusive, and the ratio of Sn and Co contents (Co/(Sn+Co)) may be from 20 mass % to 70 mass % both inclusive, since thereby, high energy density is obtained.

It may be preferable that the SnCoC-containing material have a phase containing Sn, Co, and C. Such a phase may be preferably low-crystalline or amorphous. The phase is a reaction phase capable of reacting with lithium. Therefore, due to existence of the reaction phase, superior characteristics are obtained. The half bandwidth of the diffraction peak obtained by X-ray diffraction of the phase may be preferably equal to or greater than 1 deg based on diffraction angle of 2θ in the case where CuKα ray is used as a specific X ray, and the insertion rate is 1 deg/min. Thereby, lithium is more smoothly inserted and extracted, and reactivity with the electrolytic solution is decreased. It is to be noted that, in some cases, the SnCoC-containing material includes a phase containing a simple substance or part of the respective constituent elements in addition to the low-crystalline phase or the amorphous phase.

Whether or not the diffraction peak obtained by the X-ray diffraction corresponds to the reaction phase capable of reacting with lithium is allowed to be easily determined by comparison between X-ray diffraction charts before and after electrochemical reaction with lithium. For example, if the position of the diffraction peak after electrochemical reaction with lithium is changed from the position of the diffraction peak before the electrochemical reaction with lithium, the obtained diffraction peak corresponds to the reaction phase capable of reacting with lithium. In this case, for example, the diffraction peak of the low crystalline reaction phase or the amorphous reaction phase may be seen in the range of 2θ=from 20 deg to 50 deg both inclusive. Such a reaction phase may have, for example, the foregoing respective constituent elements, and the low crystalline or amorphous structure thereof possibly results from existence of carbon mainly.

In the SnCoC-containing material, part or all of carbon as a constituent element may be preferably bonded to a metal element or a metalloid element as other constituent element, since cohesion or crystallization of tin and/or the like is suppressed thereby. The binding state of elements is allowed to be checked with the use, for example, of X-ray photoelectron spectroscopy (XPS). In a commercially available device, for example, as a soft X ray, Al—Kα ray, Mg—Kα ray, or the like may be used. In the case where part or all of carbon are bound to a metal element, a metalloid element, or the like, the peak of a synthetic wave of 1 s orbit of carbon (C is) is shown in a region lower than 284.5 eV. It is to be noted that in the device, energy calibration is made so that the peak of 4f orbit of gold atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Therefore, for example, analysis may be made with the use of commercially available software to isolate both peaks from each other. In the waveform analysis, the position of the main peak existing on the lowest bound energy side is the energy standard (284.8 eV).

It is to be noted that the SnCoC-containing material is not limited to the material (SnCoC) configured of only Sn, Co, and C as constituent elements. That is, the SnCoC-containing material may further contain, for example, any one or more of Si, Fe, Ni, Cr, In, Nb, Ge, Ti, Mo, Al, P, Ga, Bi, and the like as constituent elements in addition to Sn, Co, and C.

In addition to the SnCoC-containing material, a material (an SnCoFeC-containing material) containing Sn, Co, Fe, and C as constituent elements may be also preferable. The composition of the SnCoFeC-containing material may be arbitrarily set. For example, the composition in which the Fe content may be set small is as follows. That is, the C content may be from 9.9 mass % to 29.7 mass % both inclusive, the Fe content may be from 0.3 mass % to 5.9 mass % both inclusive, and the ratio (Co/(Sn+Co)) of contents of Sn and Co may be from 30 mass % to 70 mass % both inclusive. Further, the composition in which the Fe content is set large is as follows. That is, the C content may be from 11.9 mass % to 29.7 mass % both inclusive, the ratio ((Co+Fe)/(Sn+Co+Fe)) of contents of Sn, Co, and Fe may be from 26.4 mass % to 48.5 mass % both inclusive, and the ratio (Co/(Co+Fe)) of contents of Co and Fe may be from 9.9 mass % to 79.5 mass % both inclusive. In such a composition range, high energy density is obtained. It is to be noted that physicality (such as half bandwidth) of the SnCoFeC-containing material is similar to the physicality of the foregoing SnCoC-containing material.

In addition thereto, the anode material may be, for example, any one or more of metal oxides, polymer compounds, and the like. Examples of the metal oxides may include iron oxide, ruthenium oxide, and molybdenum oxide. Examples of the polymer compounds may include polyacetylene, polyaniline, and polypyrrole. It goes without saying that the anode material is not limited to any of the foregoing materials, and may be other material.

The anode active material layer 14B may be formed, for example, by any one or more of a coating method, a vapor-phase deposition method, a liquid-phase deposition method, a spraying method, a firing method (a sintering method), and the like. The coating method may be a method in which, for example, after a particulate (powder) anode active material is mixed with an anode binder and/or the like, the resultant mixture is dispersed in a solvent such as an organic solvent, and the anode current collector 14A is coated with the resultant. Examples of the vapor-phase deposition method may include a physical deposition method and a chemical deposition method. More specifically, examples thereof may include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method may include an electrolytic plating method and an electroless plating method. The spraying method is a method in which an anode active material in a fused state or a semi-fused state is sprayed to the anode current collector 14A. The firing method may be a method in which after the anode current collector 14A is coated with a mixture dispersed in a solvent with the use, for example, of a coating method, heat treatment is performed at temperature higher than the melting point of the anode binder and/or the like. Examples of the firing method may include an atmosphere firing method, a reactive firing method, and a hot press firing method.

In the secondary battery, as described above, in order to prevent lithium metal from being unintentionally precipitated on the anode 14 in the middle of charge, the electrochemical equivalent of the anode material capable of inserting and extracting lithium may be preferably larger than the electrochemical equivalent of the cathode. Further, in the case where the open circuit voltage (that is, a battery voltage) at the time of fully-charged state is equal to or greater than 4.25 V, the extraction amount of lithium per unit mass is large compared to that in the case where the open circuit voltage is 4.20 V even if the same cathode active material is used. Therefore, amounts of the cathode active material and the anode active material are adjusted accordingly. Thereby, high energy density is obtainable.

[Separator]

The separator 15 separates the cathode 13 from the anode 14, and passes lithium ions while preventing current short circuit resulting from contact of both electrodes. The separator 15 may be, for example, any one or more of a porous films made of a synthetic resin, ceramics, and/or the like. The separator 15 may be a laminated film in which two or more kinds of porous films are laminated. Examples of the synthetic resin may include any one or more of polytetrafluoroethylene, polypropylene, and polyethylene.

In particular, the separator 15 may include, for example, a polymer compound layer on a single surface or both surfaces of the foregoing porous film (the base material layer). Thereby, adhesibility of the separator 15 with respect to the cathode 13 and the anode 14 is improved, and therefore, skewness of the spirally wound electrode body 10 is suppressed. Thereby, a decomposition reaction of the electrolytic solution is suppressed, and liquid leakage of the electrolytic solution with which the base material layer is impregnated is suppressed. Accordingly, even if charge and discharge are repeated, the resistance is less likely to be increased, and battery swollenness is suppressed.

The polymer compound layer may contain, for example, a polymer material such as polyvinylidene fluoride, since such a polymer material has a superior physical strength and is electrochemically stable. However, the polymer material may be a polymer material other than polyvinylidene fluoride. In the case of forming the polymer compound layer, for example, after a solution in which the polymer material is dissolved is prepared, the base material layer is coated with the solution, and the solution is subsequently dried. Alternatively, the base material layer may be soaked in the solution, and the solution may be subsequently dried.

[Electrolyte Layer]

An electrolyte layer 16 may be, for example, provided on one or both of the cathode 13 (the cathode active material layer 13B) and the anode 14 (the anode active material layer 14B). However, FIG. 2 and FIG. 3 illustrate a case in which the electrolyte layer 16 (16X) is provided on the cathode active material layer 13B and the electrolyte layer 16 (16Y) is provided on the anode active material layer 14B.

In the electrolyte layer 16, an electrolytic solution as a liquid electrolyte is supported by a polymer compound. The electrolyte layer 16 is a so-called gel electrolyte, since thereby, high ion conductivity (such as 1 mS/cm or more at room temperature) is obtained and liquid leakage of the electrolytic solution is prevented. The electrolyte layer 16 may further contain any one or more of other materials such as an additive.

The polymer compound contains any one or more of polymer materials. Examples of the polymer materials may include polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. In particular, polyvinylidene fluoride may be preferable, since the polyvinylidene fluoride is electrochemically stable. In addition thereto, examples of the polymer materials may include a copolymer. Examples of the copolymer may include a copolymer of vinylidene fluoride and hexafluoro propylene.

The electrolytic solution contains a solvent and an electrolyte salt. However, the electrolytic solution may contain any one or more of other materials such as an additive.

The solvent contains any one or more of non-aqueous solvents such as an organic solvent. The electrolytic solution containing a non-aqueous solvent as a solvent is a so-called non-aqueous electrolytic solution.

Examples of the non-aqueous solvents may include a cyclic ester carbonate, a chain ester carbonate, lactone, a chain carboxylic ester, and nitrile, since thereby, a superior battery capacity, superior cycle characteristics, superior conservation characteristics, and the like are obtained. Examples of the cyclic ester carbonate may include ethylene carbonate, propylene carbonate, and butylene carbonate. Examples of the chain ester carbonate may include dimethyl carbonate, diethyl carbonate, ethyl methyl carbonate, and methylpropyl carbonate. Examples of the lactone may include γ-butyrolactone and γ-valerolactone. Examples of the carboxylic ester may include methyl acetate, ethyl acetate, methyl propionate, ethyl propionate, methyl butyrate, methyl isobutyrate, methyl trimethylacetate, and ethyl trimethylacetate. Examples of the nitrile may include acetonitrile, glutaronitrile, adiponitrile, methoxyacetonitrile, and 3-methoxypropionitrile.

In addition thereto, examples of the non-aqueous solvents may include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitro methane, nitroethane, sulfolane, trimethyl phosphate, and dimethyl sulfoxide. Thereby, a similar advantage is obtained.

In particular, any one or more of ethylene carbonate, propylene carbonate, dimethyl carbonate, diethyl carbonate, and ethyl methyl carbonate may be preferable, since thereby, a superior battery capacity, superior cycle characteristics, superior conservation characteristics, and the like are obtained. In this case, a combination of a high viscosity (high dielectric constant) solvent (for example, specific dielectric constant ∈≧30) such as ethylene carbonate and propylene carbonate and a low viscosity solvent (for example, viscosity≦1 mPa·s) such as dimethyl carbonate, ethylmethyl carbonate, and diethyl carbonate may be more preferable. One reason for this is that the dissociation property of the electrolyte salt and ion mobility are improved.

In particular, the non-aqueous solvent may contain any one or more of an unsaturated cyclic ester carbonate, a halogenated ester carbonate, sultones (cyclic sulfonic esters), acid anhydrides, and the like, since thereby, chemical stability of the electrolytic solution is improved. The unsaturated cyclic ester carbonate is a cyclic ester carbonate having one or more unsaturated bonds (carbon-carbon double bonds), and may be, for example, vinylene carbonate, vinylethylene carbonate, methyleneethylene carbonate, or the like. The halogenated ester carbonate is a cyclic ester carbonate or a chain ester carbonate containing one or more halogens as constituent elements. Examples of the cyclic halogenated ester carbonate may include 4-fluoro-1,3-dioxole-2-one, and 4,5-difluoro-1,3-dioxole-2-one. Examples of the chain halogenated ester carbonate may include fluoromethyl methyl carbonate, bis(fluoromethyl) carbonate, and difluoromethyl methyl carbonate. Examples of the sultones may include propane sultone and propene sultone. Examples of the acid anhydrides may include a succinic anhydride, an ethane disulfonic anhydride, and a sulfobenzoic anhydride. However, examples of the non-aqueous solvent may include compounds other than the foregoing compounds.

It is to be noted that, in the electrolyte layer 16 as a gel electrolyte, the term “solvent of the electrolytic solution” refers to a wide concept including not only the foregoing liquid solvent but also a material having ion conductivity capable of dissociating an electrolyte salt. Therefore, in the case where a polymer compound having ion conductivity is used, such a polymer compound is also included in the solvent.

The electrolyte salt may contain, for example, any one or more of salts such as lithium salts. However, the electrolyte salt may contain, for example, a salt other than the lithium salt. Examples of “the salt other than the lithium salt” may include a light metal salt other than the lithium salt.

Examples of the lithium salts may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr). Thereby, a superior battery capacity, superior cycle characteristics, superior conservation characteristics, and the like are obtained.

In particular, any one or more of LiPF₆, LiBF₄, LiClO₄, and LiAsF₆ may be preferable, and LiPF₆ may be more preferable, since the internal resistance is thereby lowered, and therefore, a higher effect is obtained. However, examples of the electrolyte salt may include compounds other than the foregoing compounds.

Although the content of the electrolyte salt is not particularly limited, in particular, the content thereof may be preferably from 0.3 mol/kg to 3.0 mol/kg both inclusive with respect to the solvent, since high ion conductivity is obtained thereby.

[Surface Observation of Electrolyte Layer]

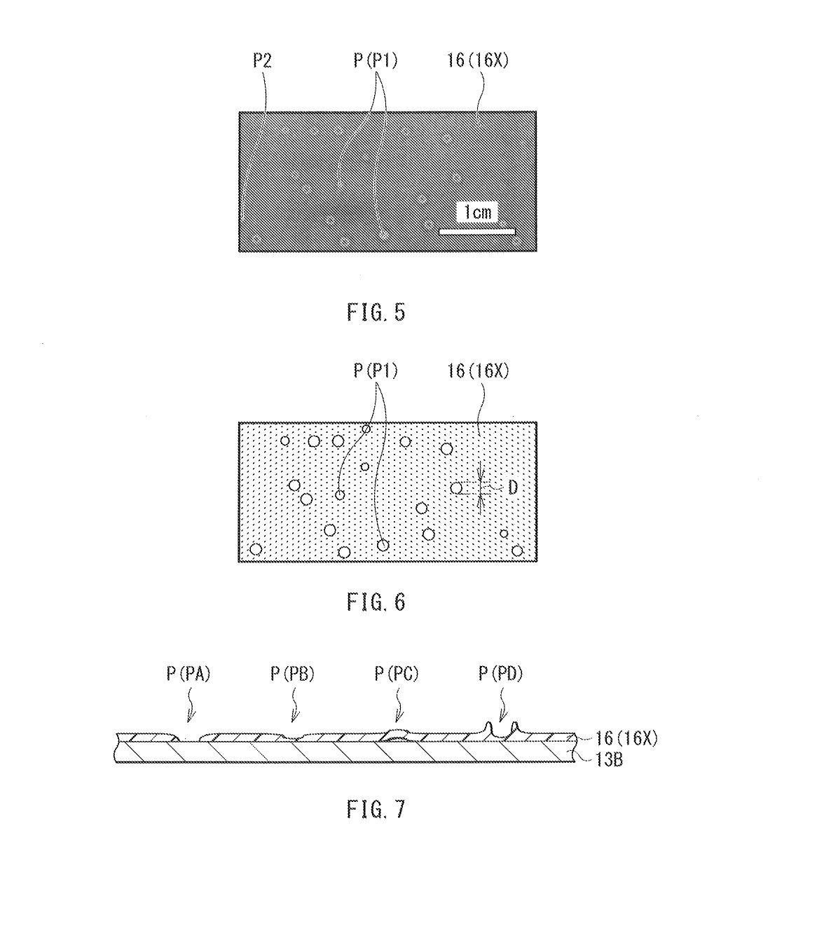

FIG. 4 to FIG. 7 are figures for explaining observation results of the electrolyte layer 16. FIG. 4 and FIG. 5 illustrate results of surface observation (photomicrographs) of the electrolyte layer 16, and FIG. 6 schematically illustrates the photomicrograph illustrated in FIG. 5. FIG. 7 is a figure for explaining causes of occurrence of after-described circular regions P, and selectively illustrates part (the cathode active material layer 13B and the electrolyte layer 16) of the spirally wound electrode body 10 illustrated in FIG. 3.

The electrolyte layer 16X provided on the cathode active material layer 13B is formed after supply treatment of a pretreatment-use liquid for the surface of the cathode active material layer 13B. That is, the electrolyte layer 16X is formed by supplying the pretreatment-use liquid to the surface of the cathode active material layer 13B, and thereafter supplying an electrolyte-use solution to the surface of the cathode active material layer 13B. The pretreatment-use liquid is a liquid (a non-aqueous liquid) not containing a polymer compound, and the electrolyte-use solution is a liquid (a non-aqueous liquid) containing an electrolytic solution together with the polymer compound. It is to be noted that the pretreatment-use liquid may contain the electrolytic solution, or may not contain the electrolytic solution. For details of a step of forming of the electrolyte layer 16X using the pretreatment-use liquid and the electrolyte-use solution, description will be given later.

Through the step of forming the electrolyte layer 16X, the formation state of the electrolyte layer 16X becomes appropriate so that superior battery characteristics are obtained thereby. Therefore, results of surface observation of the electrolyte layer 16X satisfy any of the following first condition and the following second condition.

Surfaces S1 and S2 of the electrolyte layer 16X are observed with the use of a microscope. Examples of the microscope may include any one or more of an optical microscope and the like. For example, since an optical microscope is used here, the photos illustrated in FIG. 4 and FIG. 5 are optical photomicrographs. Upon observation with the use of the microscope, any places out of the surfaces 51 and S2 of the electrolyte layer 16X are observed under conditions that the observation area size is 46 cm×4 cm and the number of observation areas is 1, and thereafter, the observation results (photomicrographs) are visually recognized. It is to be noted that the magnification at the time of observation may be any value, as long as the circular regions P (see FIG. 5) are allowed to be visually recognized in the foregoing observation area size, and a diameter D of each of the circular regions P is measurable.

In the first condition, as illustrated in FIG. 4, even when the surfaces S1 and S2 of the electrolyte layer 16X are observed, the circular regions P (see FIG. 5) are not observed. That is, since the formation state of the electrolyte layer 16X has been optimized, the circular regions P are not visually recognized in the result (the photomicrograph) obtained by observing any places out of the surfaces S1 and S2 of the electrolyte layer 16X.

In the second condition, as illustrated in FIG. 5 and FIG. 6, when the surfaces S1 and S2 of the electrolyte layer 16X are observed, one or more circular regions P are observed. That is, since the formation state of the electrolyte layer 16X is not optimized, the circular regions P are visually recognized in the photomicrograph.

Each of the circular regions P is a substantially circular region observed in the photomicrograph, and may be a vestige caused by, for example, air bubbles mixed therein mainly in the step of forming the electrolyte layer 16X. The shape (the outline shape) defined by the outer rim of the vestige may be substantially circular, and is not limited to a true circle. That is, the outline shape is not particularly limited, as long as the outline shape is a shape including a curved line, and may be an oval or other shape. Further, internal color of the vestige is light color (color relatively close to white), while outer color (base color) of the vestige is dark color (color relatively close to black). Therefore, due to the contrasting density (contrast), the vestige is visually recognized as a circular region. However, the circular region P includes not only a region in which the internal color is light color entirely but also a region recognized ring-shaped (or crater-shaped) since color of portions other than the central portion out of the internal portion is light color. Further, contrast allowing the circular regions P to be visually recognized includes not only a case in which the internal portion is light-colored and the outer portion is dark-colored, but also a case in which the internal portion is dark-colored and the outer portion is light-colored.

In the case where the circular regions P are observed, an average diameter AD (mm) of the circular regions P is kept small as much as possible, and is specifically equal to or less than 1.3 mm. In the case where the number of the circular regions P is one, the term “average diameter AD” refers to the diameter D of the circular region P. In the case where the number of the circular regions P is equal to or larger than two, the term “average diameter AD” refers to an average value of the diameters D of such two or more circular regions P. However, the diameter D may be, for example, a diameter of the circle of equal perimeter.

Upon obtaining the average diameter AD of the circular regions P, first, any places out of the surfaces S1 and S2 of the electrolyte layer 16X are observed with the use of a microscope to obtain a photomicrograph. Observation conditions such as observation area size are similar to those of the first condition. Each of the diameters D of the circular regions P is from about 1 mm to about 2 mm both inclusive, while the observation area (46 cm×4 cm) is sufficiently wide (available to visually recognize a sufficient number of circular regions P). Therefore, as described above, one observation area is enough for observation. Subsequently, each of the diameters D (mm) of the respective circular regions P is measured with the use of the photomicrograph. However, as illustrated in FIG. 5 and FIG. 6, the circular regions P whose diameters D should be measured include only circular regions P1 whose entire images are contained in the observation area out of one or more circular regions P visually regarded in the observation area. That is, while each of the diameters D of the circular regions P (P1) whose entire images are contained in the observation area is measured, each of the diameters D of circular regions P (P2) whose entire images are not contained in the observation area is not measured. FIG. 6 illustrates only the outer rims (the outlines) of the circular regions P1 whose diameters D should be measured. It is to be noted that in the case where the shape of the circular region P is a shape other than a true circle such as an oval, the maximum diameter may be the diameter D. Finally, the average value of the diameters D is calculated to obtain the average diameter AD.

In particular, in order to improve calculation accuracy of the average diameter AD, image processing may be used for determining presence or absence of the circular regions P. In this case, first, each of the diameters D of the respective circular regions P is artificially measured with the use of a microphotograph to obtain each of maximum values MD1 of the diameters D. Subsequently, planarization process is performed on the photomicrograph with the use of image analysis software. The image analysis software is analySIS Pro version 3.2 available from Soft Imaging System GmbH. In the planarization process, contrast is adjusted so that regions having the same height are displayed in the same color, and therefore, outlines of the circular regions P and the like become clear. Subsequently, each of the diameters D of the respective circular regions P is artificially measured with the use of a microphotograph after the planarization process to calculate each of maximum values MD2 of the diameters D. Finally, contrast is adjusted so that the maximum values MD1 and MD2 become the same.

It is to be noted that in the case where the surfaces of the electrolyte layer 16X are observed to examine presence or absence of the circular regions P and the diameters D, a secondary battery that is immediately after manufacturing or before usage (before charge and discharge) may be used, or a secondary battery after usage (after charge and discharge) may be used. One reason for this is that, the formation state of the electrolyte layer 16X (presence or absence of the circular regions P and the diameter D) is retained having little influence from charge and discharge, and therefore, a similar observation result is obtained without depending on presence or absence of charge and discharge in surface observation of the electrolyte layer 16X.

The reason why any of the foregoing first condition and the foregoing second condition is satisfied with regard to results of surface observation of the electrolyte layer 16X is as follows.

In the step of forming the electrolyte layer 16X, as described above, after the electrolyte-use solution containing the polymer compound and the electrolytic solution is prepared, the electrolyte-use solution is supplied to the surface of the cathode active material layer 13B. Thereby, a plurality of air gaps existing in the cathode active material layer 13 are permeated with the electrolytic solution. Further, the polymer compound supporting the electrolytic solution turns into a film on the surface of the cathode active material layer 13B, and therefore, the electrolyte layer 16X containing the polymer compound and the electrolytic solution is formed to cover the surface of the cathode active material layer 13B. In this case, in order to allow lithium to be easily inserted and extracted in the entire cathode active material layer 13B, deep portions of the cathode active material layer 13B may be preferably permeated with the electrolytic solution.

However, the number of air gaps existing in the cathode active material layer 13B is enormous, and the air gap size is significantly minute. Accordingly, deep portions of the cathode active material layer 13B tend to be less likely to be permeated with the electrolytic solution inherently and potentially. Further, when the electrolyte-use solution is supplied to the surface of the cathode active material layer 13B in the step of forming the electrolyte layer 16X, the electrolytic solution enters part of the air gaps existing in the cathode active material layer 13B, and accordingly, air existing in the other air gaps is pushed to the surface of the cathode active material layer 13B. Accordingly, air bubbles tend to be mixed in the electrolyte layer 16X. As described above, vestiges (air bubble vestiges) resulting from mixture of air bubbles into the electrolyte layer 16X are visually regarded as the circular regions P when the surfaces S1 and S2 of the electrolyte layer 16X are observed.

Reasons for the event that the circular regions P are observed resulting from mixture of air bubbles into the electrolyte layer 16X may include, for example, several examples as illustrated in FIG. 7.

Firstly, in the case where part of the electrolyte layer 16X is removed due to mixture of air bubbles and the cathode active material layer 13B is partly exposed, a circular region P (PA) is observed. Secondly, in the case where the thickness of part of the electrolyte layer 16X becomes smaller than the thickness of the other portions, a circular region P (PB) is observed. Thirdly, in the case where part of the electrolyte layer 16X is pushed up due to mixture of air bubbles and a gap is created between such part of the electrolyte layer 16X and the cathode active material layer 13B, a circular region P (PC) is observed. Fourthly, in the case where part of the electrolyte layer 16X is intensely deformed due to mixture of air bubbles, the electrolyte layer 16X is risen in the surrounding portion other than the central portion, and therefore, a circular region P (PD) in a state of a crater is observed.

The four types of examples (the circular regions PA to PD) have been exemplified here as reasons for observation of the circular regions P. However, the reasons are not limited to the foregoing examples, and the circular regions P may be observed in other examples for the reasons therefor.

Accordingly, in the case where the electrolytic solution permeability with respect to the cathode active material layer 13B is not sufficient, lithium is less likely to be smoothly and sufficiently inserted and extracted in the cathode active material layer 13B. Further, in the case where air bubbles are mixed into the electrolyte layer 16X, for example, due to the partial removal of the electrolyte layer 16X illustrated in FIG. 7, lithium may be less likely to be moved from the cathode 13 to the anode 14. Therefore, insertion and extraction of lithium are inhibited at the time of charge and discharge, and therefore, it is difficult to obtain a sufficient battery capacity, and in particular, the capacity is easily lowered at the time of initial charge and discharge.

With regard to the foregoing point, in this embodiment, due to the step of forming the electrolyte layer 16X with the use of the pretreatment-use liquid, the electrolytic solution permeability with respect to the cathode active material layer 13B is sufficiently improved. Thereby, minute air gaps existing in the cathode active material layer 13B are sufficiently filled with the electrolytic solution, and therefore, air is less likely to be pushed to the surface of the cathode active material layer 13B. In particular, since the amount of air existing in the cathode active material layer 13B is sufficiently small here, the formation state of the electrolyte layer 16X is less likely to be affected by air (air bubbles). Therefore, as in the foregoing first condition, when the surfaces S1 and S2 of the electrolyte layer 16X are observed with the use of a microscope or the like, the circular regions P are not observed. Thereby, a significantly high battery capacity is obtained, and in particular, a capacity close to the theoretical capacity is obtained from the initial charge and discharge.

Alternatively, in this embodiment, even if the electrolytic solution permeability with respect to the cathode active material layer 13B is not sufficient, the electrolytic solution permeability is secured to the degree that air pushed to the surface of the cathode active material layer 13B does not excessively affect the formation state of the electrolyte layer 16X. Therefore, as in the foregoing second condition, when the surfaces S1 and S2 of the electrolyte layer 16X are observed with the use of a microscope or the like, one or more circular regions P are observed. However, each of the diameters D of the circular regions P is kept to the degree that the circular regions P do not excessively affect the formation state of the electrolyte layer 16X. Specifically, the average diameter AD of the circular regions P calculated by the foregoing procedure is equal to or less than 1.3 mm. Thereby, a sufficient battery capacity is obtained, and in particular, a high capacity is obtained from the initial charge and discharge.

As described above, the battery capacity of the secondary battery, the electrolytic solution permeability with respect to the cathode active material layer 13B, and the formation state of the electrolyte layer 16X (presence or absence of the circular regions P and the average diameter AD thereof) are correlated. That is, in the case where the electrolytic solution permeability is lowered, since the formation state of the electrolyte layer 16X is easily affected by air bubbles, the circular regions P are generated and the average diameter AD of the circular regions P is increased, and therefore, the battery capacity is lowered. In contrast, in the case where the electrolytic solution permeability is improved, since the formation state of the electrolyte layer 16X is less likely to be affected by air bubbles, the circular regions P are not generated, or the average diameter AD is kept low even if the circular regions P are generated, and therefore, a high battery capacity is obtained. Based on the correlation, the formation state of the electrolyte layer 16X (presence or absence of the circular regions P and the average diameter AD thereof) becomes an index to evaluate the battery capacity (the electrolytic solution permeability) of the secondary battery. That is, even if the battery capacity of the secondary battery is not measured practically, whether or not a sufficient battery capacity is obtainable is allowed to be indirectly determined by observing the formation state of the electrolyte layer 16X to examine presence or absence of the circular regions P and the average diameter AD thereof.

The reason why the foregoing first condition and the foregoing second condition are determined with respect to the electrolyte layer 16X provided in the cathode active material layer 13B is as follows.

For example, as described later, in the case where lithium is extracted from the cathode 13 at the time of charge, the absolute amount of lithium extracted from the cathode 13 to the anode 14 largely affects the battery capacity, in particular, the capacity at the time of charge and discharge. Specifically, in the case where the absolute amount of lithium extracted from the cathode 13 to the anode 14 is large, a high battery capacity is obtained. In contrast, in the case where the absolute amount of lithium is small, a sufficient battery capacity is not obtained. With regard thereto, in the case where a result of surface observation of the electrolyte layer 16X satisfies the first condition or the second condition, the foregoing partial removal of the electrolyte layer 16X is less likely to occur. Thereby, a sufficient amount of lithium is extracted from the cathode 13 to the anode 14 through the electrolyte layer 16X, and therefore, a high battery capacity is obtained.

The foregoing advantage is significant, in particular, in the case where area density of the cathode active material layer 13B is high, more specifically, in the case where the area density is equal to or larger than 40 mg/cm². In the case where the area density is less than 40 mg/cm², the cathode active material layer 13B is easily permeated with the electrolytic solution fundamentally without coating with the pretreatment-use liquid, and therefore, the electrolytic solution permeability is less likely to be affected by coating treatment of the pretreatment-use liquid. In other words, in the case where the area density is equal to or larger than 40 mg/cm², size of air gaps existing in the cathode active material layer 13 becomes sufficiently small, and therefore, the electrolytic solution is less likely to fundamentally enter the air gaps. In this case, the cathode active material layer 13B is less likely to be permeated with the electrolytic solution unless coating of the pretreatment-use liquid is performed. Therefore, the electrolytic solution permeability is largely affected by such coating treatment of the pretreatment-use liquid. It is to be noted that though the range of the area density is not particularly limited as long as the area density is equal to or larger than 40 mg/cm², in particular, the area density may be preferably from 40 mg/cm² to 53 mg/cm² both inclusive.

The foregoing “area density” refers to area density of the entire cathode active material layer 13B. That is, the area density in the case where the cathode active material layer 13B is provided only on a single surface of the cathode current collector 13A refers to area density of the foregoing single cathode active material layer 13B. Further, the area density in the case where the cathode active material layers 13B are provided on both surfaces of the cathode current collector 13A refers to area density of the foregoing two cathode active material layers 13B.

The electrolytic solution permeability with respect to the cathode active material layer 13B may be changed according to the conditions such as the thickness of the cathode 13. More specifically, when the thickness of the cathode 13 is increased, the range (permeance distance) in which the cathode active material layer 13B should be permeated with the electrolytic solution is increased. Thereby, deep portions of the cathode active material layer 13B are less likely to be permeated with the electrolytic solution, and therefore, the permeability is lowered.

Though the thickness of the cathode 13 is not particularly limited, the thickness thereof may be preferably equal to or larger than 82 μm, and may be more preferably from 82 μm to 144 μm both inclusive. Alternatively, the thickness of the cathode 13 may be preferably, for example, 110 μm, and may be more preferably from 110 μm to 145 μm both inclusive. One reason for this is that, in this case, even if deep portions of the cathode active material layer 13B are less likely to be permeated with the electrolytic solution inherently and potentially due to a large thickness of the cathode 13, the electrolytic solution permeability is improved.

The foregoing “thickness” refers to the entire thickness of the cathode active material layer 13B as the foregoing area density does. That is, the thickness in the case where the cathode active material layer 13B is provided only on a single surface of the cathode current collector 13A refers to a thickness of the foregoing single cathode active material layer 13B. Further, the thickness in the case where the cathode active material layers 13B are provided on both surfaces of the cathode current collector 13A refers to the total of the thicknesses of the foregoing two cathode active material layers 13B.

[Operation of Secondary Battery]

The secondary battery may operate, for example, as follows. At the time of charge, when lithium is extracted from the cathode 13, the lithium is inserted in the anode 14 through the electrolyte layer 16. In contrast, at the time of discharge, when lithium is extracted from the anode 14, the lithium is inserted in the cathode 13 through the electrolyte layer 16.

[1-2. Manufacturing Method]

The secondary battery may be manufactured, for example, by the following procedure.

[Fabrication Step of Cathode]

First, the cathode 13 is fabricated. In this case, for example, a cathode active material is mixed with other materials such as a cathode binder to prepare a cathode mixture. Subsequently, the cathode mixture is dispersed in an organic solvent or the like to obtain paste cathode mixture slurry. Subsequently, both surfaces of the cathode current collector 13A are coated with the cathode mixture slurry, and the cathode mixture slurry is dried to form the cathode active material layer 13B. Thereafter, the cathode active material layer 13B may be compression-molded with the use of a roll pressing machine and/or the like. In this case, compression-molding may be performed while heating the cathode active material layer 13B, or compression-molding treatment of the cathode active material layer 13B may be repeated several times.

[Fabrication Step of Anode]

Next, the anode 14 is fabricated by a procedure similar to the foregoing procedure of the cathode 13. In this case, an anode mixture obtained by mixing an anode active material and other materials such as an anode binder is dispersed in an organic solvent or the like to form paste anode mixture slurry. Subsequently, both surfaces of the anode current collector 14A are coated with the anode mixture slurry, and the anode mixture slurry is dried to form the anode active material layer 14B. Thereafter, the anode active material layer 14B may be compression-molded by a procedure similar to that in the case of compression-molding the cathode active material layer 13B.

[Formation Step of Electrolyte Layer]

Next, the electrolyte layer 16 is formed on each of the cathode 13 and the anode 14.

Upon forming the electrolyte layer 16X on the cathode 13, a pretreatment-use liquid is prepared. Differently from an electrolyte-use solution containing solid contents of a polymer compound, an electrolyte salt, and the like, the pretreatment-use liquid is any one or more of non-aqueous liquids not containing solid contents thereof. However, the non-aqueous liquid may contain an electrolytic solution, or may not contain the electrolytic solution. That is, the non-aqueous liquid may be the electrolytic solution itself, or may contain other materials (materials other than the polymer compound) together with the electrolytic solution, as long as the non-aqueous liquid does not contain the polymer compound. Types of the pretreatment-use liquid are not particularly limited, as long as the pretreatment-use liquid is any one or more of non-aqueous liquids. More specifically, the non-aqueous liquid not containing the electrolytic solution may be, for example, similar to specific examples of the non-aqueous solvent contained in the electrolytic solution. Further, the non-aqueous liquid containing the electrolytic solution may be, for example, the electrolytic solution itself, or may be a mixture of the electrolytic solution and any one or more of non-aqueous solvents.

Subsequently, the pretreatment-use liquid is supplied to the surface of the cathode active material layer 13B, and the cathode active material layer 13B is permeated (impregnated) with the pretreatment-use liquid. By the supply treatment of the pretreatment-use liquid, the pretreatment-use liquid enters air gaps in the cathode active material layer 13B, and therefore, the internal portions (internal wall surfaces forming the air gaps) of the cathode active material layer 13B are wetted with the pretreatment-use liquid. In this case, since wettability of the internal wall surfaces of the cathode active material layer 13B is changed, the internal wall surfaces are easily wetted with the same type of liquid as that of the pretreatment-use liquid. The foregoing “same type of liquid” refers to an electrolyte-use liquid or the like that contains a nonaqueous solvent as the pretreatment-use liquid does, since the pretreatment-use liquid is a non-aqueous liquid (containing a nonaqueous solvent). Thereby, the viscosity of the pretreatment-use liquid not containing the foregoing solid contents is lower than that of the electrolyte-use liquid, and the pretreatment-use liquid is smoothly and actively introduced into the cathode active material layer 13B with the use of the so-called capillarity. Therefore, deep portions of the cathode active material layer 13B are impregnated with the pretreatment-use liquid.

In particular, the viscosity of the pretreatment-use liquid may be preferably, for example, equal to or less than 30 mPa/s at 25 deg C. One reason for this is that, in this case, the pretreatment-use liquid is easily introduced into air gaps in the cathode active material layer 13B with the use of the capillarity, and therefore, inside of the cathode active material layer 13B is more easily permeated with the pretreatment-use liquid. Types of pretreatment-use liquids satisfying the foregoing viscosity conditions may be, for example, similar to the types of the non-aqueous solvents contained in the electrolytic solution, and in particular, may be preferably any one or more of cyclic ester carbonates and chain ester carbonates. Further, the steam pressure of the pretreatment-use liquid may be preferably equal to or less than 7.57 MPa at 25 deg C. One reason for this is that, in this case, since the pretreatment-use liquid with which the cathode active material layer 13B is permeated is easily volatilized, and therefore, it is less likely to inhibit the cathode active material layer 13B from being permeated with the electrolyte-use liquid in subsequent steps. Types of pretreatment-use liquids satisfying the foregoing steam pressure conditions may be, for example, similar to the types of the pretreatment-use liquids satisfying the foregoing viscosity conditions.

In particular, as described above, the electrolytic solution contains one or more non-aqueous solvents. Accordingly, the pretreatment-use liquid may preferably contain one or more of the non-aqueous solvents contained in the electrolytic solution. In other words, types of the pretreatment-use liquids may preferably the same as one or more of the non-aqueous solvents contained in the electrolytic solution. One reason for this is that, in this case, the pretreatment-use liquid and the electrolytic solution contain the common component (the non-aqueous solvent), and therefore, the internal wall surfaces in the cathode active material layer 13B after the supply treatment of the pretreatment-use liquid are further easily wetted with the electrolytic solution. Thereby, inside of the cathode active material layer 13B after the supply treatment of the pretreatment-use liquid is more easily permeated with the electrolytic solution. It goes without saying that, since the pretreatment-use liquid may be the electrolytic solution itself, the pretreatment-use liquid may be the electrolytic solution containing one or more of the foregoing non-aqueous solvents. One reason for this is that, in this case, advantages similar to those in the case where the pretreatment-use liquid is one or more of the non-aqueous solvents.

It is to be noted that, upon supplying the pretreatment-use liquid to the surface of the cathode active material layer 13B, for example, the surface of the cathode active material layer 13B may be coated with the pretreatment-use liquid, or the cathode active material layer 13B may be soaked into the pretreatment-use liquid. Conditions such as the density, the supply amount, and the supply time of the pretreatment-use liquid may be any conditions. It goes without saying that the method of supplying the pretreatment-use liquid may be a method other than the foregoing method, as long as the method allows the cathode active material layer 13B to be permeated with the pretreatment-use liquid.

Thereafter, the cathode active material layer 13B supplied with the pretreatment-use liquid may be left to dry (volatilize) the pretreatment-use liquid. In this case, the volatilization amount of the pretreatment-use liquid is changed according to drying time, and therefore, the amount of the pretreatment-use liquid remaining in the cathode active material layer 13B is adjustable. That is, in the case where the drying time is shortened, the volatilization amount is decreased and therefore, the remaining amount of the pretreatment-use liquid is increased. In contrast, in the case where the drying time is increased, the volatilization amount is increased and therefore, the remaining amount of the pretreatment-use liquid is decreased.

Subsequently, the electrolyte-use solution containing the polymer compound and the electrolytic solution is prepared, and thereafter, the electrolyte-use solution is supplied to the surface of the cathode active material layer 13B supplied with the pretreatment-use liquid. The electrolyte-use solution is obtained by dispersing or dissolving the polymer compound in the electrolytic solution. The type of the polymer compound and the composition of the electrolytic solution are as described before for the configuration of the electrolyte layer 16. However, the electrolyte-use liquid may contain any one or more of other materials such as a diluent organic solvent.

By the supply treatment of the electrolyte-use solution, the electrolyte-use solution turns into a film on the surface of the cathode active material layer 13B. Therefore, the electrolyte layer 16X containing the polymer compound and the electrolytic solution is formed on the surface of the cathode active material layer 13B.

In this case, by the foregoing supply treatment of the pretreatment-use liquid, the internal wall surface of the cathode active material layer 13B is easily wetted with a non-aqueous solvent. Therefore, the electrolytic solution easily enters air gaps in the cathode active material layer 13B. Thereby, as in the case where deep portions of the cathode active material layer 13B are easily permeated with the pretreatment-use liquid in the supply treatment of the pretreatment-use liquid, deep portions of the cathode active material layer 13B are easily permeated with the electrolytic solution in the electrolyte-use liquid in the supply treatment of the electrolyte-use liquid. That is, the electrolytic solution in the electrolyte-use liquid supplied to the surface of the cathode active material layer 13B easily reach not only a portion in the vicinity of the surface of the cathode active material layer 13B but also a portion in the vicinity of the bottom surface thereof.

Further, since the pretreatment-use liquid enters deep portions of the cathode active material layer 13B, the air amount remaining in the cathode active material layer 13B is decreased. Therefore, when the electrolyte-use liquid turns into a film, air bubbles are less likely to be mixed in the film. Thereby, when the surfaces S1 and S2 of the electrolyte layer 16X are observed with the use of a microscope, the circular regions P are less likely to be observed on the surfaces S1 and S2. In this case, as described above, in the case where most of air does not remain in the cathode active material layer 13B, the circular regions P are not observed in the surfaces S1 and S2 of the electrolyte layer 16X. Alternatively, in the case where air remains in the cathode active material layer 13B but the air amount has been sufficiently decreased, the circular regions P are observed on the surfaces S1 and S2 of the electrolyte layer 16X while the average diameter AD of the circular regions P is sufficiently small, and is specifically equal to or less than 1.3 mm.

It is to be noted that, upon forming the electrolyte layer 16Y on the anode 14, for example, a procedure similar to that of the case of forming the electrolyte layer 16X on the cathode 13 may be used, except that the supply treatment of the pretreatment-use liquid is not performed.

[Step of Assembling Secondary Battery]

Upon assembling the secondary battery, the cathode lead 11 is attached to the cathode current collector 13A with the use of a welding method and/or the like, and the anode lead 12 is attached to the anode current collector 14A with the use of a welding method and/or the like. Subsequently, the cathode 13 in which the electrolyte layer 16X is formed on the cathode active material layer 13B and the anode 14 in which the electrolyte layer 16Y is formed on the anode active material layer 14B are layered with the separator 15 in between to form a laminated body. Subsequently, the laminated body is spirally wound to fabricate the spirally wound electrode body 10. Thereafter, the protective tape 17 is adhered to the outermost periphery of the spirally wound electrode body 10. Subsequently, after the spirally wound electrode body 10 is sandwiched between two pieces of film-like outer package members 20, the outer edges of the outer package members 20 are adhered with the use of a thermal fusion bonding method and/or the like. Thereby, the spirally wound electrode body 10 is enclosed into the outer package members 20. In this case, the adhesive films 21 are inserted between the cathode lead 11 and the outer package member 20 and between the anode lead 12 and the outer package member 20. Thereby, the secondary battery is completed.

[1-3. Function and Effect]

According to the secondary battery, the electrolyte layer 16X containing the polymer compound and the electrolytic solution is provided on the surface of the cathode active material layer 13B. The electrolyte layer 16X is formed by supplying the pretreatment-use liquid to the surface of the cathode active material layer 13B, and thereafter, supplying the electrolyte-use liquid to the surface of the cathode active material layer 13B. Accordingly, by surface observation of the electrolyte layer 16X with the use of a microscope, the circular regions P are not observed. Alternatively, even if one or more circular regions P are observed, the average diameter AD of the circular regions P is kept to a value equal to or less than 1.3 mm.

Thereby, as described above, since deep portions of the cathode active material layer 13B are permeated with the electrolytic solution in the electrolyte layer 16X, lithium is smoothly and sufficiently inserted and extracted in the entire cathode active material layer 13B. Further, since the mixture amount of air bubbles with respect to the electrolyte layer 16X is suppressed, insertion and extraction of lithium are less likely to be inhibited at the time of charge and discharge. Therefore, a high battery capacity is obtained. In particularly, since a high capacity is obtained from the initial charge and discharge, superior battery characteristics are obtainable.

In this case, in the case where the area density of the cathode active material layer 13B is equal to or larger than 40 mg/cm², the cathode active material layer 13B tends to be less likely to be permeated with the electrolytic solution in the electrolyte layer 16X fundamentally and potentially, and therefore, a higher effect is obtainable.

In particular, since the electrolyte layer 16X is provided on the cathode active material layer 13B, when lithium is extracted from the cathode 13 at the time of charge, a sufficient amount of lithium is extracted from the cathode 13 to the anode 14 through the electrolyte layer 16. Therefore, a higher battery capacity is obtainable.

Further, according to the method of manufacturing the secondary battery, in the step of forming the electrolyte layer 16X, after the pretreatment-use liquid is supplied to the surface of the cathode active material layer 13B, the electrolyte-use solution is supplied to the surface of the cathode active material layer 13B supplied with the pretreatment-use liquid.

Thereby, as described above, due to the pretreatment-use liquid that has entered air gaps in the cathode active material layer 13B, the internal wall surface of the cathode active material layer 13B forming the air gaps is easily wetted with the non-aqueous solvent. Therefore, the deep portions of the cathode active material layer 13B are easily permeated with the electrolytic solution in the electrolyte-use liquid. Further, when the electrolyte-use solution turns into a film, air bubbles are less likely to be mixed in the film. Therefore, even when the surfaces S1 and S2 of the electrolyte layer 16X are observed with the use of a microscope, the circular regions P are not observed. Alternatively, even if one or more circular regions P are observed, the average diameter AD of the circular regions P is kept to a value equal to or less than 1.3 mm. Therefore, since a high battery capacity is obtained, a secondary battery having superior battery characteristics is allowed to be manufactured.

In particular, in the case where the viscosity of the pretreatment-use liquid is equal to or less than 30 mPa/s at 25 deg C., or the steam pressure of the pretreatment-use liquid is equal to or less than 7.57 MPa at 25 deg C., a higher effect is obtainable. Further, in the case where the pretreatment-use liquid contains one or more of the non-aqueous solvents in the electrolytic solution, a higher effect is obtainable.

[1-4 Modifications]

Results of surface observation of the electrolyte layer 16X provided on the cathode active material layer 13B satisfy the foregoing first condition or the foregoing second condition. However, results of surface observation of the electrolyte layer 16Y provided on the anode active material layer 14B may satisfy similar conditions. In this case, the electrolyte layer 16Y is formed on the surface of the anode active material layer 14B by a procedure similar to that of the case in which the electrolyte layer 16X is formed on the surface of the cathode active material layer 13B. That is, in a step of forming the electrolyte layer 16Y on the surface of the anode active material layer 14B, the foregoing supply treatment of the pretreatment-use liquid and the foregoing supply treatment of the electrolyte-use solution are performed in this order. In this case, effects similar to those in the case where the results of surface observation of the electrolyte layer 16X satisfy the first condition or the second condition are obtainable.

It goes without saying that both the results of surface observation of the electrolyte layer 16X and the results of surface observation of the electrolyte layer 16Y may satisfy the first condition or the second condition. In this case, since insertion and extraction of lithium are further less likely to be inhibited in the cathode 13 and the anode 14, a higher effect is obtainable.

[2. Applications of Secondary Battery]

The foregoing secondary battery may be applied to, for example, the following applications.

Applications of the secondary battery are not particularly limited as long as the secondary battery is applied to a machine, a device, an instrument, an apparatus, a system (collective entity of a plurality of devices and the like), or the like that is allowed to use the secondary battery as a driving electric power source, an electric power storage source for electric power storage, or the like. The secondary battery used as an electric power source may be a main electric power source (electric power source used preferentially), or may be an auxiliary electric power source (electric power source used instead of a main electric power source or used being switched from the main electric power source). In the case where the secondary battery is used as an auxiliary electric power source, the main electric power source type is not limited to the secondary battery.

Examples of applications of the secondary battery may include electronic apparatuses (including portable electronic apparatuses) such as a video camcorder, a digital still camera, a mobile phone, a notebook personal computer, a cordless phone, a headphone stereo, a portable radio, a portable television, and a personal digital assistant. Further examples thereof may include a mobile lifestyle electric appliance such as an electric shaver; a memory device such as a backup electric power source and a memory card; an electric power tool such as an electric drill and an electric saw; a battery pack used for a notebook personal computer or the like as an attachable and detachable electric power source; a medical electronic apparatus such as a pacemaker and a hearing aid; an electric vehicle such as an electric automobile (including a hybrid automobile); and an electric power storage system such as a home battery system for storing electric power for emergency or the like. It goes without saying that an application other than the foregoing applications may be adopted.

In particular, the secondary battery is effectively applicable to the battery pack, the electric vehicle, the electric power storage system, the electric power tool, the electronic apparatus, or the like. One reason for this is that, in these applications, since superior battery characteristics are demanded, performance is effectively improved with the use of the secondary battery according to the embodiment of the present application. It is to be noted that the battery pack is an electric power source using a secondary battery, and is a so-called assembled battery or the like. The electric vehicle is a vehicle that works (runs) with the use of a secondary battery as a driving electric power source. As described above, the electric vehicle may be an automobile (such as a hybrid automobile) including a drive source other than a secondary battery. The electric power storage system is a system using a secondary battery as an electric power storage source. For example, in a home electric power storage system, since electric power is stored in the secondary battery as an electric power storage source, the electric power is utilized, and thereby, home electric products and the like become usable. The electric power tool is a tool in which a movable section (such as a drill) is moved with the use of a secondary battery as a driving electric power source. The electronic apparatus is an apparatus executing various functions with the use of a secondary battery as a driving electric power source (electric power supply source).

Description will be specifically given of some application examples of the secondary battery. It is to be noted that the configurations of the respective application examples explained below are merely examples, and may be changed as appropriate.

[2-1. Battery Pack]

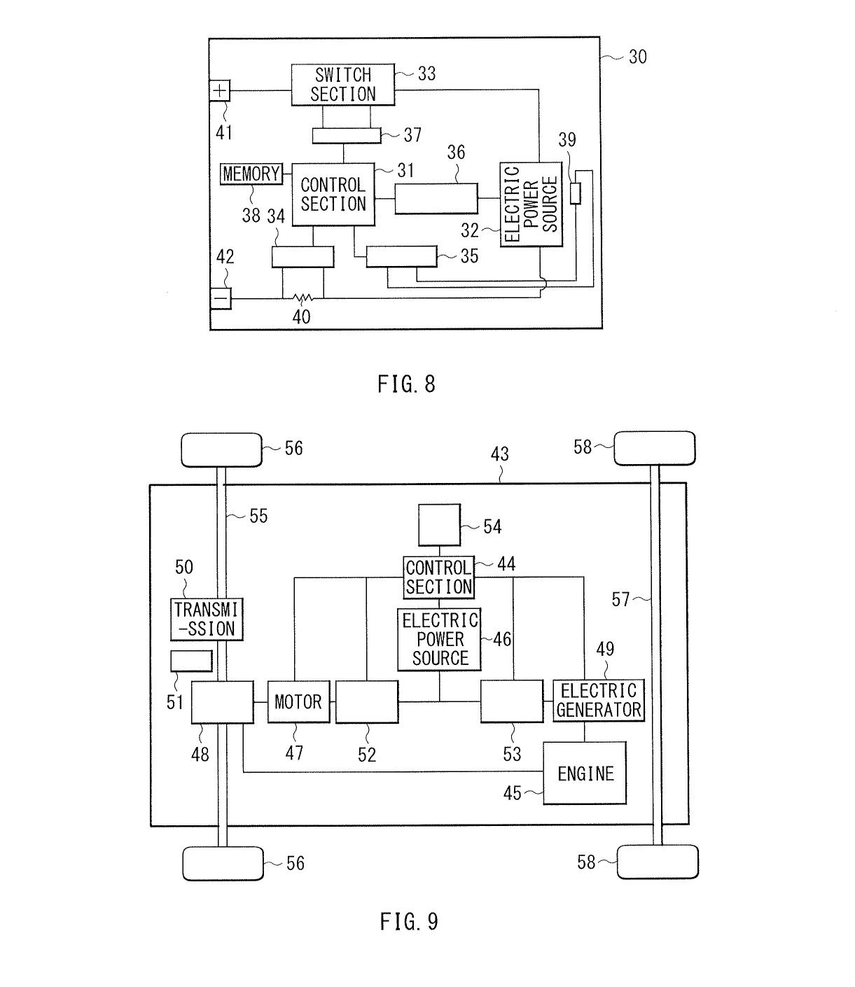

FIG. 8 illustrates a block configuration of a battery pack. For example, the battery pack may include a control section 31, an electric power source 32, a switch section 33, a current measurement section 34, a temperature detection section 35, a voltage detection section 36, a switch control section 37, a memory 38, a temperature detection element 39, a current detection resistance 40, a cathode terminal 41, and an anode terminal 42 in a housing 30 made of a plastic material and/or the like.

The control section 31 controls operation of the whole battery pack (including operation of the electric power source 32), and may include, for example, a central processing unit (CPU) and/or the like. The electric power source 32 includes one or more secondary batteries (not illustrated). The electric power source 32 may be, for example, an assembled battery including two or more secondary batteries. Connection type of these secondary batteries may be a series-connected type, may be a parallel-connected type, or a mixed type thereof. As an example, the electric power source 32 may include six secondary batteries connected in a manner of dual-parallel and three-series.

The switch section 33 switches the operation of the electric power source 32 (whether or not the electric power source 32 is connectable to an external device) according to an instruction of the control section 31. The switch section 33 may include, for example, a charge control switch, a discharge control switch, a charging diode, a discharging diode, and the like (not illustrated). The charge control switch and the discharge control switch may each be, for example, a semiconductor switch such as a field-effect transistor (MOSFET) using a metal oxide semiconductor.

The current measurement section 34 measures a current with the use of the current detection resistance 40, and outputs the measurement result to the control section 31. The temperature detection section 35 measures temperature with the use of the temperature detection element 39, and outputs the measurement result to the control section 31. The temperature measurement result may be used for, for example, a case in which the control section 31 controls charge and discharge at the time of abnormal heat generation or a case in which the control section 31 performs a correction processing at the time of calculating a remaining capacity. The voltage detection section 36 measures a voltage of the secondary battery in the electric power source 32, performs analog-to-digital conversion on the measured voltage, and supplies the resultant to the control section 31.

The switch control section 37 controls operations of the switch section 33 according to signals inputted from the current measurement section 34 and the voltage detection section 36.

The switch control section 37 executes control so that a charging current is prevented from flowing in a current path of the electric power source 32 by disconnecting the switch section 33 (charge control switch) in the case where, for example, a battery voltage reaches an overcharge detection voltage. Thereby, in the electric power source 32, only discharge is allowed to be performed through the discharging diode. It is to be noted that, for example, in the case where a large current flows at the time of charge, the switch control section 37 blocks the charging current.

Further, the switch control section 37 executes control so that a discharging current is prevented from flowing in the current path of the electric power source 32 by disconnecting the switch section 33 (discharge control switch) in the case where, for example, a battery voltage reaches an overdischarge detection voltage. Thereby, in the electric power source 32, only charge is allowed to be performed through the charging diode. It is to be noted that, for example, in the case where a large current flows at the time of discharge, the switch control section 37 blocks the discharging current.

It is to be noted that, in the secondary battery, for example, the overcharge detection voltage may be 4.20 V±0.05 V, and the over-discharge detection voltage may be 2.4 V±0.1 V.

The memory 38 may be, for example, an EEPROM as a non-volatile memory or the like. The memory 38 may store, for example, numerical values calculated by the control section 31, information of the secondary battery measured in a manufacturing step (such as an internal resistance in the initial state), and the like. It is to be noted that, in the case where the memory 38 stores a full charging capacity of the secondary battery, the control section 31 is allowed to comprehend information such as a remaining capacity.

The temperature detection element 39 measures temperature of the electric power source 32, and outputs the measurement result to the control section 31. The temperature detection element 39 may be, for example, a thermistor or the like.

The cathode terminal 41 and the anode terminal 42 are terminals connected to an external device (such as a notebook personal computer) driven using the battery pack or an external device (such as a battery charger) used for charging the battery pack. The electric power source 32 is charged and discharged through the cathode terminal 41 and the anode terminal 42.

[2-2. Electric Vehicle]

FIG. 9 illustrates a block configuration of a hybrid automobile as an example of electric vehicles. For example, the electric vehicle may include a control section 44, an engine 45, an electric power source 46, a driving motor 47, a differential 48, an electric generator 49, a transmission 50, a clutch 51, inverters 52 and 53, and various sensors 54 in a housing 43 made of metal. In addition thereto, the electric vehicle may include, for example, a front drive shaft 55 and a front tire 56 that are connected to the differential 48 and the transmission 50, a rear drive shaft 57, and a rear tire 58.

The electric vehicle may run with the use, for example, of one of the engine 45 and the motor 47 as a drive source. The engine 45 is a main power source, and may be, for example, a petrol engine. In the case where the engine 45 is used as a power source, drive power (torque) of the engine 45 may be transferred to the front tire 56 or the rear tire 58 through the differential 48, the transmission 50, and the clutch 51 as drive sections, for example. The torque of the engine 45 may also be transferred to the electric generator 49. Due to the torque, the electric generator 49 generates alternating-current electric power. The alternating-current electric power is converted into direct-current electric power through the inverter 53, and the converted power is stored in the electric power source 46. In contrast, in the case where the motor 47 as a conversion section is used as a power source, electric power (direct-current electric power) supplied from the electric power source 46 is converted into alternating-current electric power through the inverter 52. The motor 47 may be driven by the alternating-current electric power. Drive power (torque) obtained by converting the electric power by the motor 47 may be transferred to the front tire 56 or the rear tire 58 through the differential 48, the transmission 50, and the clutch 51 as the drive sections, for example.

It is to be noted that, alternatively, the following mechanism may be adopted. In the mechanism, when speed of the electric vehicle is reduced by an unillustrated brake mechanism, the resistance at the time of speed reduction is transferred to the motor 47 as torque, and the motor 47 generates alternating-current electric power by the torque. It may be preferable that the alternating-current electric power be converted to direct-current electric power through the inverter 52, and the direct-current regenerative electric power be stored in the electric power source 46.

The control section 44 controls operations of the whole electric vehicle, and, for example, may include a CPU and/or the like. The electric power source 46 includes one or more secondary batteries (not illustrated). Alternatively, the electric power source 46 may be connected to an external electric power source, and electric power may be stored by receiving the electric power from the external electric power source. The various sensors 54 may be used, for example, for controlling the number of revolutions of the engine 45 or for controlling opening level (throttle opening level) of an unillustrated throttle valve. The various sensors 54 may include, for example, a speed sensor, an acceleration sensor, an engine frequency sensor, and/or the like.

It is to be noted that the description has been given above of the hybrid automobile as an electric vehicle. However, examples of the electric vehicles may include a vehicle (electric automobile) working with the use of only the electric power source 46 and the motor 47 without using the engine 45.

[2-3. Electric Power Storage System]

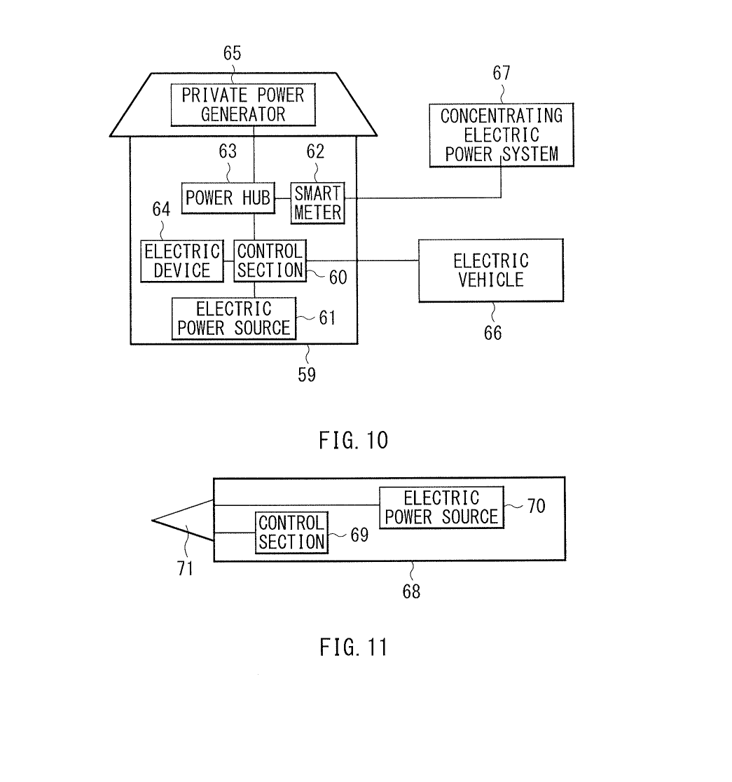

FIG. 10 illustrates a block configuration of an electric power storage system. For example, the electric power storage system may include a control section 60, an electric power source 61, a smart meter 62, and a power hub 63 inside a house 59 such as a general residence and a commercial building.

In this case, the electric power source 61 may be connected to, for example, an electric device 64 arranged inside the house 59, and may be connected to an electric vehicle 66 parked outside the house 59. Further, for example, the electric power source 61 may be connected to a private power generator 65 arranged inside the house 59 through the power hub 63, and may be connected to an external concentrating electric power system 67 thorough the smart meter 62 and the power hub 63.

It is to be noted that the electric device 64 may include, for example, one or more home electric appliances such as a refrigerator, an air conditioner, a television, and a water heater. The private power generator 65 may be, for example, any one or more of a solar power generator, a wind-power generator, and the like. The electric vehicle 66 may be, for example, any one or more of an electric automobile, an electric motorcycle, a hybrid automobile, and the like. The concentrating electric power system 67 may be, for example, any one or more of a thermal power plant, an atomic power plant, a hydraulic power plant, a wind-power plant, and the like.

The control section 60 controls operation of the whole electric power storage system (including operation of the electric power source 61), and, for example, may include a CPU and/or the like. The electric power source 61 includes one or more secondary batteries (not illustrated). The smart meter 62 may be, for example, an electric power meter compatible with a network arranged in the house 59 demanding electric power, and may be communicable with an electric power supplier. Accordingly, for example, while the smart meter 62 communicates with outside, the smart meter 62 controls the balance between supply and demand in the house 59 and allows effective and stable energy supply.

In the electric power storage system, for example, electric power may be stored in the electric power source 61 from the concentrating electric power system 67 as an external electric power source through the smart meter 62 and the power hub 63, and electric power may be stored in the electric power source 61 from the private power generator 65 as an independent electric power source through the power hub 63. The electric power stored in the electric power source 61 is supplied to the electric device 64 or to the electric vehicle 66 according to an instruction of the control section 60. Therefore, the electric device 64 becomes operable, and the electric vehicle 66 becomes chargeable. That is, the electric power storage system is a system capable of storing and supplying electric power in the house 59 with the use of the electric power source 61.

The electric power stored in the electric power source 61 is arbitrarily usable. Therefore, for example, electric power is allowed to be stored in the electric power source 61 from the concentrating electric power system 67 in the middle of the night when an electric rate is inexpensive, and the electric power stored in the electric power source 61 is allowed to be used during daytime hours when an electric rate is expensive.

It is to be noted that the foregoing electric power storage system may be arranged for each household (family unit), or may be arranged for a plurality of households (family units).

[2-4. Electric Power Tool]

FIG. 11 illustrates a block configuration of an electric power tool. For example, the electric power tool may be an electric drill, and may include a control section 69 and an electric power source 70 in a tool body 68 made of a plastic material and/or the like. For example, a drill section 71 as a movable section may be attached to the tool body 68 in an operable (rotatable) manner.

The control section 69 controls operations of the whole electric power tool (including operation of the electric power source 70), and may include, for example, a CPU and/or the like. The electric power source 70 includes one or more secondary batteries (not illustrated). The control section 69 allows electric power to be supplied from the electric power source 70 to the drill section 71 according to operation of an unillustrated operation switch to operate the drill section 71.

### EXAMPLES

Specific Examples according to the embodiment of the present application will be described in detail.

### Examples 1-1 to 1-21

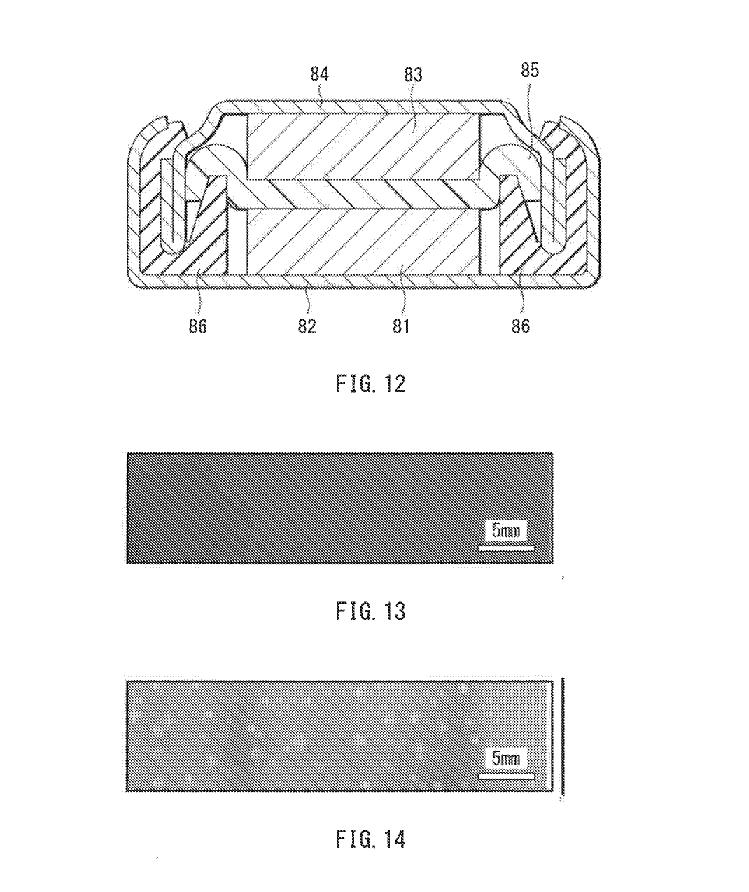

As a test-use secondary battery, a coin-type lithium ion secondary battery illustrated in FIG. 12 was fabricated. In the secondary battery, a test electrode 81 corresponding to a cathode and a counter electrode 83 corresponding to an anode were laminated with a separator 85 in between, and a package can 82 containing the test electrode 81 and a package cup 84 containing the counter electrode 83 were swaged with a gasket 86.

Upon fabricating the test electrode 81, 98 parts by mass of a cathode active material (LiCoO₂), 1.2 parts by mass of a cathode binder (polyvinylidene fluoride: PVDF), and 0.8 parts by mass of a cathode electric conductor (graphite) were mixed to obtain a cathode mixture. Subsequently, the cathode mixture was dispersed in an organic solvent (N-methyl-2-pyrrolidone: NMP) to obtain paste-like cathode mixture slurry. Subsequently, both surfaces of a cathode current collector (a strip-shaped aluminum foil being 12 μm thick) were coated with the cathode mixture slurry with the use of an applicator, and the cathode mixture slurry was dried to form a cathode active material layer. In this case, as illustrated in Table 1, the area density (mg/cm²) and the thickness (μm) of the cathode active material layer were adjusted. Subsequently, the cathode active material layer was pressure-molded with the use of a roll pressing machine so that the volume density of the cathode active material layer became 3.65 g/cm³.

Upon fabricating the counter electrode 83, 92.5 parts by mass of an anode active material (artificial graphite), 4.5 parts by mass of an anode binder (PVDF), and 3 parts by mass of an anode electric conductor (vapor-grown carbon fiber: VGCF) were mixed to obtain an anode mixture. Subsequently, the anode mixture was dispersed in an organic solvent (NMP) to obtain paste-like anode mixture slurry. Subsequently, both surfaces of an anode current collector (a strip-shaped copper foil being 10 μm thick) were coated with the anode mixture slurry with the use of an applicator, and the anode mixture slurry was dried to form an anode active material layer. In this case, area densities (mg/cm²) of the anode active material layer were 17.4 mg/cm² (34 mg/cm²), 20.5 mg/cm² (40 mg/cm²), 22.5 mg/cm² (44 mg/cm²), 24.3 mg/cm² (48 mg/cm²), and 27.1 mg/cm² (53 mg/cm²). Each of the values in parenthesis refers to the area density of the cathode active material layer. Definition of the area density of the anode active material layer is similar to the definition of the area density of the cathode active material layer. Subsequently, the anode active material layer was pressure-molded with the use of a roll pressing machine so that the volume density of the anode active material layer became 1.57 g/cm³.

Upon forming the electrolyte layer, an electrolytic solution was prepared by dissolving an electrolyte salt (LiPF₆) in a solvent (ethylene carbonate and propylene carbonate). In this case, the composition of the solvent was ethylene carbonate:propylene carbonate=1:1 at a weight ratio, and the content of the electrolyte salt was 1.08 mol/kg with respect to the solvent. Subsequently, 3.6 parts by mass of a polymer compound (a copolymer of vinylidene fluoride and hexafluoropropylene), 51.1 parts by mass of an electrolytic solution, and 45.3 parts by mass of a diluent (dimethyl carbonate) were mixed while stirring. In this case, the copolymer amount of hexafluoropropylene was 6.9%. Thereby, since the polymer compound was dissolved in the electrolytic solution and the diluent, a sol electrolyte-use solution was obtained.

Upon forming the electrolyte layer in the test electrode 81, after the surface of the cathode active material layer was coated with a pretreatment-use liquid, the pretreatment-use liquid was naturally dried. Types and drying time (time) of the pretreatment-use liquid were as illustrated in Table 1. It is to be noted that PC refers to propylene carbonate, DMC refers to dimethyl carbonate, EC refers to ethylene carbonate, and the mixture ratio between EC and PC refers to a weight ratio. Subsequently, the surface of the cathode active material layer coated with the pretreatment-use liquid was coated with an electrolyte-use liquid, and the electrolyte-use liquid was dried. In this case, the coating rate was 20 m/min, and the drying conditions were 90 deg C. and 2 minutes. Thereby, the diluent was volatilized, and the polymer compound supporting the electrolytic solution turned into a film on the surface of the cathode active material layer, and therefore, the electrolyte layer was formed. In this case, for comparison, the electrolyte layer was formed without coating the surface of the cathode active material layer with the pretreatment-use liquid.

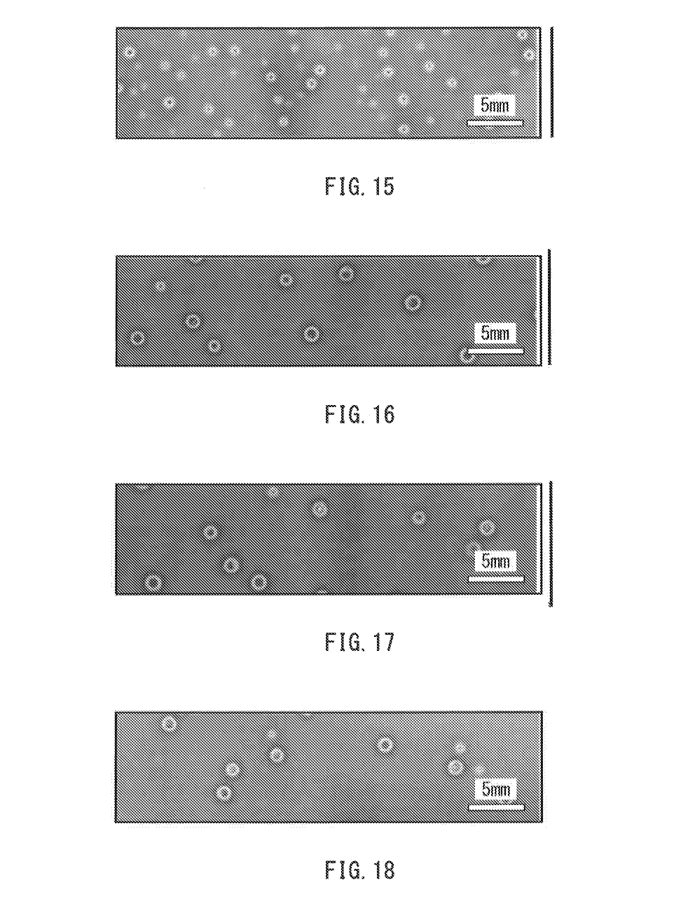

Thereafter, by the foregoing procedure and under the foregoing conditions, the surface of the electrolyte layer provided on the cathode active material layer was observed. Results of the surface observation of the electrolyte layer (Examples 1-1 to 1-5, 1-8, and 1-16) were as illustrated in FIG. 13 to FIG. 19. Further, when presence or absence of circular regions and the average diameters thereof (mm) were examined, results illustrated in Table 1 were obtained.

Upon forming the electrolyte layer in the counter electrode 83, a procedure similar to that in the case where the electrolyte layer was formed on the surface of the cathode active material layer was used, except that the surface of the anode active material layer was not coated with the pretreatment-use liquid.

Upon assembling the secondary battery, after the test electrode 81 was punched out into a pellet (diameter: 15 mm), the test electrode 81 was contained in a package can 82. Subsequently, after the counter electrode 83 was punched out into a pellet (diameter: 16 mm), the counter electrode 83 was contained in the package cup 84. Subsequently, after the test electrode 81 contained in the package can 82 and the counter electrode 83 contained in the package cup 84 were layered with the separator 85 (a microporous polyolefin film being 23 μm thick) in between, the package can 82 and the package cup 84 were swaged with the gasket 86. Thereby, the coin-type secondary battery was completed.

As battery characteristics of the secondary battery, battery capacities at the time of initial charge and discharge were examined. Results illustrated in Table 1 were obtained. Upon examining the battery capacities, after the secondary battery was charged at a current of 0.2 C until the voltage reached 4.3 V, the secondary battery was charged at a voltage of 4.3 V until the total charging time reached 8 hours. Subsequently, the secondary battery was discharged at a constant current of 0.2 C until the voltage reached 3 V to measure the discharge capacity (mAh). Finally, the discharge capacity was divided by the weight (g) of the cathode active material, and thereby, the battery capacity (mAh/g) was calculated. “0.2 C” is a current value at which a battery capacity (a theoretical capacity) is fully discharged in 5 hours. It is to be noted that “change amount (mAh/g)” illustrated in Table 1 refers to an increased amount of the battery capacity according to presence or absence of coating with the pretreatment-use liquid.

TABLE 1

| | | | Pretreatment- | | | | | |
|---|---|---|---|---|---|---|---|---|
| | | | use | | Circular | | | |
| | Cathode | | liquid | | region | | | |
| | Area | | | Drying | Presence | Average | Battery | Change |
| | density | Thickness | | time | or | diameter | capacity | amount |
| Example | (mg/cm²) | (μm) | Type | (Time) | absence | (mm) | (mAh/g) | (mAh/g) |
| 1-1 | 48 | 132 | PC | 0.5 | Absent | — | 174 | +4 |
| 1-2 | 48 | 132 | PC | 1 | Present | 0.8 | 174 | — |
| 1-3 | 48 | 132 | PC | 1.5 | Present | 0.9 | 173 | — |
| 1-4 | 48 | 132 | PC | 3 | Present | 1.2 | 173 | — |
| 1-5 | 48 | 132 | PC | 3.85 | Present | 1.3 | 172 | — |
| 1-6 | 48 | 132 | PC | 3.95 | Present | 1.3 | 172 | — |
| 1-7 | 48 | 132 | PC | 4 | Present | 1.3 | 171 | — |
| 1-8 | 48 | 132 | PC | 4.35 | Present | 1.3 | 171 | — |
| 1-9 | 40 | 110 | PC | 0.5 | Absent | — | 174 | +2 |
| 1-10 | 44 | 121 | PC | 0.5 | Absent | — | 174 | +3 |
| 1-11 | 53 | 145 | PC | 0.5 | Absent | — | 173 | +5 |
| 1-12 | 48 | 132 | DMC | 0.5 | Absent | — | 173 | — |
| 1-13 | 53 | 145 | EC:PC = 1:1 | 0.5 | Absent | — | 174 | — |
| 1-14 | 53 | 145 | EC:PC = 1:2 | 0.5 | Absent | — | 174 | — |
| 1-15 | 53 | 145 | EC:PC = 1:3 | 0.5 | Absent | — | 174 | — |
| 1-16 | 48 | 132 | — | — | Present | 1.8 | 170 | — |
| 1-17 | 40 | 110 | — | — | Present | 1.4 | 172 | — |
| 1-18 | 44 | 121 | — | — | Present | 1.6 | 171 | — |
| 1-19 | 53 | 145 | — | — | Present | 1.9 | 168 | — |
| 1-20 | 34 | 93 | PC | 0.5 | Absent | — | 174 | +0 |
| 1-21 | 34 | 93 | — | — | Present | 1 | 174 | — |

In the case where coating of the pretreatment-use liquid was performed under the condition that the area density of the cathode active material layer was high, the battery capacity was increased without depending on conditions such as types of the pretreatment-use liquid, compared to in the case where coating of the pretreatment-use liquid was not performed.

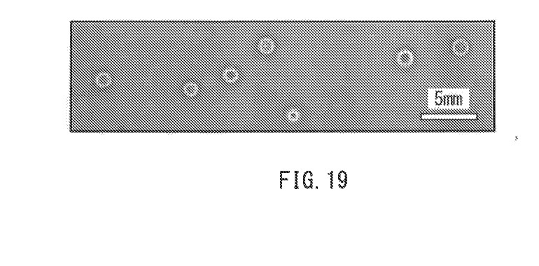

More specifically, in the case where coating of the pretreatment-use liquid was not performed (Examples 1-16 to 1-19), as illustrated in FIG. 19, when the electrolyte layer provided on the cathode active material layer was observed, a plurality of circular regions were viewed. In this case, since the average diameter of the circular regions was excessively large, specifically, exceeded 1.3 mm, a sufficient battery capacity was not obtained.

In contrast, in the case where coating of the pretreatment-use liquid was performed (Examples 1-1 to 1-15), under the condition that the drying time was short (Example 1-1), circular regions were not observed as illustrated in FIG. 13. Therefore, a significant high battery capacity was obtained. Such an event that circular regions were not observed was similarly seen in the case where the area density of the cathode active material layer was changed (Examples 1-9 to 1-11) and in the case where the type of pretreatment-use liquid was changed (Examples 1-12 to 1-15).

Further, in the case where coating of the pretreatment-use liquid was performed and the drying time was long (Examples 1-2 to 1-8), as illustrated in FIG. 14 to FIG. 18, a plurality of circular regions were observed. However, since the average diameter of the plurality of circular regions was sufficiently kept low, specifically, was equal to or less than 1.3 mm, a high battery capacity was obtained. In this case, in general, as the drying time was increased, the average diameter was gradually increased, and accordingly, the battery capacity tended to be gradually decreased.

However, it does not mean that coating of the pretreatment-use liquid simply resulted in an increased battery capacity. That is, in the case where the area density of the cathode active material layer was low (Examples 1-20 and 1-21), coating of the pretreatment-use liquid resulted in change in presence or absence of circular regions, but did not result in an increased battery capacity. In contrast, in the case where the area density was high (Examples 1-1, 1-9 to 1-11, and 1-16 to 1-19), coating of the pretreatment-use liquid resulted in an increased battery capacity.

The foregoing result shows the following. The advantage obtained by coating of the pretreatment-use liquid is obtainable in the case where the area density of the cathode active material layer is high, while such an advantage is less likely to be obtained in the case where the area density is low. That is, in the case where the area density of the cathode active material layer is low, the cathode active material layer is easily permeated with the electrolytic solution without coating of the pretreatment-use liquid, and therefore, there is a tendency that a high battery capacity is inherently obtainable. Therefore, even if coating of the pretreatment-use liquid is performed, the battery capacity is not increased. In contrast, in the case where the area density of the cathode active material layer is high, the cathode active material layer is less likely to be permeated with the electrolytic solution unless coating of the pretreatment-use liquid is performed, and therefore, there is a tendency that a high battery capacity is not inherently obtainable. Therefore, by performing coating of the pretreatment-use liquid, the battery capacity is increased. From the relation between the area density and the battery capacity (change amount) illustrated in Table 1, the threshold of the area density at which the foregoing advantage is obtained by coating of the pretreatment-use liquid may be 40 mg/cm².

In particular, in the case where coating of the pretreatment-use liquid was performed, and type (PC) of the pretreatment-use liquid was the same as type of the solvent (PC) contained in the electrolytic solution, a high battery capacity was obtained.

From the results illustrated in Table 1, in the case where the electrolyte layer containing the polymer compound and the electrolytic solution was provided on the surface of the active material layer, and the area density of the active material layer was high, superior battery characteristics were obtained when circular regions were not observed by surface observation of the electrolyte layer with the use of the microscope. Alternatively, even if circular regions were observed, superior battery characteristics were obtained when the average diameter of the circular regions was equal to or less than 1.3 mm.

The present application has been described with reference to the embodiment and Examples. However, the present application is not limited to the examples described in the embodiment and Examples, and various modifications may be made. For example, the description has been given with the specific examples of the case in which the battery structure is the laminated-film-type or the coin type, and the battery element has the spirally wound structure. However, applicable structures are not limited thereto. The secondary battery of the present application is similarly applicable to a battery having other battery structure such as a square-type battery, a cylindrical-type battery, and a button-type battery, or a battery in which the battery element has other structure such as a laminated structure.

Further, the electrode of the present application is applicable not only to a secondary battery, but also to other electrochemical devices. Specific examples of such other electrochemical devices may include a capacitor.

Further, with regard to the range of the average diameter in the case where circular regions are observed by surface observation of the electrolyte layer, the description has been given of the appropriate range derived from the results of Examples. However, the description does not totally deny a possibility that the average diameter is out of the foregoing appropriate range. That is, the foregoing appropriate range is a range particularly preferable for obtaining the effects of the present application. Therefore, as long as the effects of the present application are obtained, the range may be out of the foregoing appropriate range in some degrees. The same is similarly applicable to other parameters such as thickness and area density.

It is possible to achieve at least the following configurations from the above-described example embodiments and the modifications of the disclosure.

(1) A secondary battery including:

an electrode including an active material layer; and

an electrolyte layer provided on the active material layer, wherein

area density of the active material layer is equal to or larger than about 40 milligrams per square centimeter,

the electrolyte layer includes a polymer compound and an electrolytic solution, and

by surface observation of the electrolyte layer,
(A) circular regions are not observed, or
(B) one or more circular regions are observed, and an average diameter of the circular regions is equal to or less than about 1.3 millimeters.
   (2) The secondary battery according to (1), wherein

the electrode is a cathode including a cathode active material layer, and

the electrolyte layer is provided on the cathode active material layer.

(3) The secondary battery according to (1) or (2), wherein the secondary battery is a lithium ion secondary battery.
(4) A secondary battery including:

an electrode including an active material layer; and

an electrolyte layer provided on the active material layer, wherein

the electrolyte layer is formed by supplying a non-aqueous liquid not containing a polymer compound to a surface of the active material layer, and subsequently supplying a non-aqueous solution containing an electrolytic solution together with the polymer compound to a surface of the active material layer.

(5) The secondary battery according to (4), wherein area density of the active material layer is equal to or larger than about 40 milligrams per square centimeter.
(6) The secondary battery according to (4) or (5), wherein the electrolytic solution includes one or more non-aqueous solvents and an electrolyte salt, and

the non-aqueous liquid includes one or more of the non-aqueous solvents.

(7) A method of manufacturing a secondary battery, wherein

an active material layer is formed, and

an electrolyte layer is formed by supplying a non-aqueous liquid not containing a polymer compound to a surface of the active material layer, and supplying a non-aqueous solution containing an electrolytic solution together with the polymer compound to the surface of the active material layer supplied with the non-aqueous liquid.

(8) The method according to (7), wherein

viscosity of the non-aqueous liquid is equal to or less than about 30 megapascals/second at about 25 degrees C., or

steam pressure of the non-aqueous liquid is equal to or less than about 7.57 MPa at about 25 degrees C.

(9) The method according to (7) or (8), wherein

the electrolytic solution includes one or more non-aqueous solvents and an electrolyte salt, and

the non-aqueous liquid includes one or more of the non-aqueous solvents.

(10) A battery pack including:

a secondary battery according to any one of (1) to (6);

a control section configured to control operation of the secondary battery; and

a switch section configured to switch the operation of the secondary battery according to an instruction of the control section.

(11) An electric vehicle including:

a secondary battery according to any one of (1) to (6);

a conversion section configured to convert electric power supplied from the secondary battery into drive power;

a drive section configured to operate according to the drive power; and

a control section configured to control operation of the secondary battery.

(12) An electric power storage system including:

a secondary battery according to any one of (1) to (6);

one or more electric devices configured to be supplied with electric power from the secondary battery; and

a control section configured to control the supplying of the electric power from the secondary battery to the one or more electric devices.

(13) An electric power tool including:

a secondary battery according to any one of (1) to (6); and

a movable section configured to be supplied with electric power from the secondary battery.

(14) An electronic apparatus including a secondary battery according to any one of (1) to (6) as an electric power supply source.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
an electrode including an active material layer; and
an electrolyte layer provided on the active material layer, wherein area density of the active material layer is equal to or larger than about 40 milligrams per square centimeter,
the electrolyte layer includes a polymer compound and an electrolytic solution, and
by surface observation of the electrolyte layer,
(A) circular regions are not observed, or
(B) one or more circular regions are observed, and an average diameter of the circular regions is equal to or less than about 1.3 millimeters.

2. The secondary battery according to claim 1, wherein
the electrode is a cathode including a cathode active material layer, and
the electrolyte layer is provided on the cathode active material layer.

3. The secondary battery according to claim 1, wherein the secondary battery is a lithium ion secondary battery.

4. A secondary battery comprising:
an electrode including an active material layer; and
an electrolyte layer provided on the active material layer, wherein
the electrolyte layer is formed by supplying a non-aqueous liquid not containing a polymer compound to a surface of the active material layer, and subsequently supplying a non-aqueous solution containing an electrolytic solution together with the polymer compound to a surface of the active material layer.

5. The secondary battery according to claim 4, wherein area density of the active material layer is equal to or larger than about 40 milligrams per square centimeter.

6. The secondary battery according to claim 4, wherein
the electrolytic solution includes one or more non-aqueous solvents and an electrolyte salt, and
the non-aqueous liquid includes one or more of the non-aqueous solvents.

7. A method of manufacturing a secondary battery, wherein
an active material layer is formed, and
an electrolyte layer is formed by supplying a non-aqueous liquid not containing a polymer compound to a surface of the active material layer, and supplying a non-aqueous solution containing an electrolytic solution together with the polymer compound to the surface of the active material layer supplied with the non-aqueous liquid.

8. The method according to claim 7, wherein
viscosity of the non-aqueous liquid is equal to or less than about 30 megapascals/second at about 25 degrees C., or
steam pressure of the non-aqueous liquid is equal to or less than about 7.57 MPa at about 25 degrees C.

9. The method according to claim 7, wherein
the electrolytic solution includes one or more non-aqueous solvents and an electrolyte salt, and
the non-aqueous liquid includes one or more of the non-aqueous solvents.

10. A battery pack comprising:
a secondary battery;
a control section configured to control operation of the secondary battery; and
a switch section configured to switch the operation of the secondary battery according to an instruction of the control section, wherein
the secondary battery includes
an electrode including an active material layer, and
an electrolyte layer provided on the active material layer,
area density of the active material layer is equal to or larger than about 40 milligrams per square centimeter,
the electrolyte layer includes a polymer compound and an electrolytic solution, and
by surface observation of the electrolyte layer,
(A) circular regions are not observed, or
(B) one or more circular regions are observed, and an average diameter of the circular regions is equal to or less than about 1.3 millimeters.

11. An electric vehicle comprising:
a secondary battery;
a conversion section configured to convert electric power supplied from the secondary battery into drive power;
a drive section configured to operate according to the drive power; and
a control section configured to control operation of the secondary battery, wherein
the secondary battery includes
an electrode including an active material layer, and
an electrolyte layer provided on the active material layer,
area density of the active material layer is equal to or larger than about 40 milligrams per square centimeter,
the electrolyte layer includes a polymer compound and an electrolytic solution, and
by surface observation of the electrolyte layer,
(A) circular regions are not observed, or
(B) one or more circular regions are observed, and an average diameter of the circular regions is equal to or less than about 1.3 millimeters.

12. An electric power storage system comprising:
a secondary battery;
one or more electric devices configured to be supplied with electric power from the secondary battery; and
a control section configured to control the supplying of the electric power from the secondary battery to the one or more electric devices, wherein
the secondary battery includes
an electrode including an active material layer, and
an electrolyte layer provided on the active material layer,
area density of the active material layer is equal to or larger than about 40 milligrams per square centimeter,
the electrolyte layer includes a polymer compound and an electrolytic solution, and
by surface observation of the electrolyte layer,
(A) circular regions are not observed, or
(B) one or more circular regions are observed, and an average diameter of the circular regions is equal to or less than about 1.3 millimeters.

13. An electric power tool comprising:
a secondary battery; and
a movable section configured to be supplied with electric power from the secondary battery, wherein
the secondary battery includes
an electrode including an active material layer, and
an electrolyte layer provided on the active material layer,
area density of the active material layer is equal to or larger than about 40 milligrams per square centimeter,
the electrolyte layer includes a polymer compound and an electrolytic solution, and
by surface observation of the electrolyte layer,
(A) circular regions are not observed, or
(B) one or more circular regions are observed, and an average diameter of the circular regions is equal to or less than about 1.3 millimeters.

14. An electronic apparatus comprising a secondary battery as an electric power supply source, wherein
the secondary battery includes
an electrode including an active material layer, and
an electrolyte layer provided on the active material layer,
area density of the active material layer is equal to or larger than about 40 milligrams per square centimeter,
the electrolyte layer includes a polymer compound and an electrolytic solution, and
by surface observation of the electrolyte layer,
(A) circular regions are not observed, or
(B) one or more circular regions are observed, and an average diameter of the circular regions is equal to or less than about 1.3 millimeters.
